(19) United States
(12) Patent Application Publication
(10) Pub. No.: US 2012/0036018 A1
(43) Pub. Date: Feb. 9, 2012

(54) DYNAMIC, INTERACTIVE ACTIVITY TRACKING VIA A SOCIAL MEDIA SYSTEM INTEGRATED WITH A PRODUCT MARKETING AND/OR ESTABLISHMENT ADVERTISING SYSTEM

(76) Inventors: Digna Feliciano, (US); Orlando McMaster, (US); Eustace P. Isidore, (US)

(21) Appl. No.: 12/852,926

(22) Filed: Aug. 9, 2010

(51) Int. Cl. G06Q 30/00; G06F 15/173

(52) U.S. Cl. 705/14.66; 705/14.49; 709/224

(57) ABSTRACT

A method, a system and a computer program product enables directed product advertising to users of an interactively-configured social environment/media that enables real time tracking and reporting of social activities and related information associated with usage/consumption of specific products or patronization of the social establishment by the user. An interactive stock exchange (ISE) utility pre-selects temporary target/bid prices to apply to a product during a “crash”/sales event and dynamically adjusts the standard item price towards the temporary target price, according to sales volume and/or other conditions. The ISE utility triggers an item price crash, and registered patrons are encouraged to use electronic devices to purchase items particularly at crash prices and to interact with other patrons. The ISE utility links transactions and interactions detected on the electronic devices to a member's account to track/report/advertise/market the patron's activities related to the consumption of specific products or promotion of the establishment.

### RELATED APPLICATIONS

The present application is related to pending U.S. patent application Ser. No. ______ (Attorney Docket No. EPInvent.006US1), filed on even date herewith. The entire content of the related application is hereby incorporated herein by reference.

### BACKGROUND

1. Technical Field

The present invention generally relates to interactive social media application systems and in particular to interactive social media application and advertising systems.

2. Description of the Related Art

With an ever increasing demand for more sophisticated levels of product advertisement and promotion, entertainment establishments and social networking websites are becoming increasingly popular channels for increasing product exposure, acceptance and “buzz”. As a result, social networking sites have become quite populated with advertising content. With millions of users visiting these sites, advertisers are betting heavily on the success of this advertising outlet. In addition, entertainment facilities, including nightclubs and bars, constitute another heavily utilized media for increasing product exposure and awareness.

However, the millions of visitors/members to social networking sites and nightclubs are often passive observers and are typically oblivious to advertisement on websites and in other real-life social establishments, such as bars, restaurants, and nightclubs. This potential pool of buyers and endorsers do not actively participate in the promotion of the products or services for which social establishments and social networking websites are the selected advertising media. In addition, current advertising methods within these social establishments and on websites provide fleeting exposure and conform to a non-interactive style and format.

### BRIEF SUMMARY

Disclosed are a method, a system and a computer program product for providing, tracking and reporting and/or advertising social activities and related information in an interactively configured social environment/medium. Also provided are a method, a system and a computer program product for providing multimedia interactive mechanisms in a data processing network. An interactive social/stock exchange (ISE) utility executes on a data processing system and pre-selects temporary target prices to be assigned to select items during a “crash”/sales event. The ISE utility dynamically adjusts a standard item price towards the temporary target price, according to an occurrence of one or more monitored, pre-selected conditions, including, but not limited to conditions related to volume of sales and time/schedule parameters, in one embodiment. The ISE utility displays item prices via monitors in an electronically configured establishment. When the one or more monitored conditions (that affect a change from the normal item pricing to the temporary target price) occurs, the ISE utility executes an item crash. Registered patrons are encouraged via audio-visual notification and/or other electronic form of notification to utilize electronic devices to purchase items particularly at crash prices and to interact with other patrons. The ISE utility links transactions and electronically tracked interactions to a member's local or online account (which are electronically created and updated) to record the patron's activities. In addition, according to one embodiment, business operators may electronically transmit incentive/complimentary credit and promotional items to patrons based on data associated with the patrons' activities.

In a second illustrative embodiment, commercial advertising of one or more products or establishments is supported via one or more mechanisms associated with the online presence of the users/patrons. The second illustrative embodiment provides a method, a system and a computer program product that enables directed product advertising to users of an interactively-configured social environment/media that enables real time tracking and reporting of social activities and related information associated with usage/consumption of specific products or patronization of the social establishment by the user. An interactive stock exchange (ISE) utility pre-selects temporary target/bid prices to apply to a product during a “crash”/sales event and dynamically adjusts the standard item price towards the temporary target price, according to sales volume and/or other conditions. The ISE utility triggers an item price crash, and registered patrons are encouraged to use electronic devices to purchase items particularly at crash prices and to interact with other patrons. The ISE utility links transactions and interactions detected on the electronic devices to a member's account to track/report/advertise/market the patron's activities related to the consumption of specific products or promotion of the establishment.

The above as well as additional objectives, features, and advantages of the present invention will become apparent in the following detailed written description.

### BRIEF DESCRIPTION OF THE DRAWINGS

The invention itself, as well as advantages thereof, will best be understood by reference to the following detailed description of an illustrative embodiment when read in conjunction with the accompanying drawings, wherein:

FIG. 1 provides a block diagram representation of an example data processing system within which certain features of the invention may be practiced, according to one embodiment;

FIG. 2 illustrates an example electronically configured commercial/entertainment environment equipped with a dynamic exchange system for the provision of products and services, according to one embodiment;

FIG. 3 illustrates an example electronically configured commercial/entertainment establishment during an item crash event, according to one embodiment;

FIG. 4 illustrates patron and staff interactions within the electronically configured entertainment environment of FIG. 2, according to one embodiment;

FIG. 5 illustrates a patron using an interactive transaction machine (ITM) within the electronically configured entertainment environment, according to one embodiment;

FIG. 6 illustrates an example display of a real-time item price display system, according to one embodiment;

FIG. 7 illustrates an example display of an order page to submit an online or local (near the establishment) order for a product or service, according to one embodiment;

FIG. 8 illustrates an example display of a pending orders page which indicates orders which are in the processing stage, according to one embodiment;

FIG. 9 illustrates an example display of a member homepage on a social network website configured to automatically display member activities and promotional products/services, according to one embodiment;

FIG. 10 is a flow chart illustrating the method of providing interactions between registered members, enabling transactions involving members and electronically activating special events in an electronically configured entertainment establishment, according to one embodiment;

FIG. 11 is a flow chart illustrating the method of creating specialized categories of demographic groups, populating lists based on the specialized categories, sending advertising content to particular members of these specialized categories, and forecasting the performance/success of future events, according to one embodiment;

FIG. 12 is a flow chart illustrating the method of developing a new product/service concept, obtaining approval for implementation for the product/service and advertising the introduction of the new product/service concept online, according to one embodiment;

FIG. 13 is a flow chart illustrating the method of configuring a personal area network (PAN), automatically notifying members connected to the PAN of selected member activities and reporting of particular activities to a community networking website, according to one embodiment;

FIG. 14 is a flow chart illustrating the method of externally triggering an event in a community networking site based on an event executed within an electronically configured establishment, according to one embodiment; and

FIG. 15 is a flow chart illustrating the method of reporting and advertising information/content related to member activities in an electronically configured establishment to/within a community networking site, according to one embodiment.

### DETAILED DESCRIPTION OF AN ILLUSTRATIVE EMBODIMENT

One illustrative embodiment comprises a method, a system and a computer program product for providing, tracking and reporting and/or advertising social activities and related information in an interactively configured social environment/medium. Also provided are a method, a system and a computer program product for providing multimedia interactive mechanisms in a data processing network. An interactive social/stock exchange (ISE) utility executes on a data processing system and pre-selects temporary target prices to be assigned to select items during a “crash”/sales event. The ISE utility dynamically adjusts a standard item price towards the temporary target price, according to an occurrence of one or more monitored, pre-selected conditions, including, but not limited to conditions related to volume of sales and time/schedule parameters, in one embodiment. The ISE utility displays item prices via monitors in an electronically configured establishment. When the one or more monitored conditions (that affect a change from the normal item pricing to the temporary target price) occurs, the ISE utility executes an item crash. Registered patrons are encouraged via audio-visual notification and/or other electronic form of notification to utilize electronic devices to purchase items particularly at crash prices and to interact with other patrons. The ISE utility links transactions and electronically tracked interactions to a member's local or online account (which are electronically created and updated) to record the patron's activities. In addition, according to one embodiment, business operators may electronically transmit incentive/complimentary credit and promotional items to patrons based on data associated with the patrons' activities. Also, commercial advertising of one or more products or establishments is supported via one or more mechanisms associated with the online presence of the users/patrons.

A second illustrative embodiment provides a method, a system and a computer program product that enables directed product advertising to users of an interactively-configured social environment/media that enables real time tracking and reporting of social activities and related information associated with usage/consumption of specific products or patronization of the social establishment by the user. An interactive stock exchange (ISE) utility pre-selects temporary target/bid prices to apply to a product during a “crash”/sales event and dynamically adjusts the standard item price towards the temporary target price, according to sales volume and/or other conditions. The ISE utility triggers an item price crash, and registered patrons are encouraged to use electronic devices to purchase items particularly at crash prices and to interact with other patrons. The ISE utility links transactions and interactions detected on the electronic devices to a member's account to track/report/advertise/market the patron's activities related to the consumption of specific products or promotion of the establishment.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined by the appended claims and equivalents thereof.

Within the descriptions of the figures, similar elements are provided similar names and reference numerals as those of the previous figure(s). Where a later figure utilizes the element in a different context or with different functionality, the element is provided a different leading numeral representative of the figure number. The specific numerals assigned to the elements are provided solely to aid in the description and not meant to imply any limitations (structural or functional or otherwise) on the described embodiment.

It is understood that the use of specific component, device and/or parameter names (such as those of the executing utility/logic described herein) are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized. Specifically, as utilized herein, the term “crash” refers to a significant and targeted reduction in the price of a product/service.

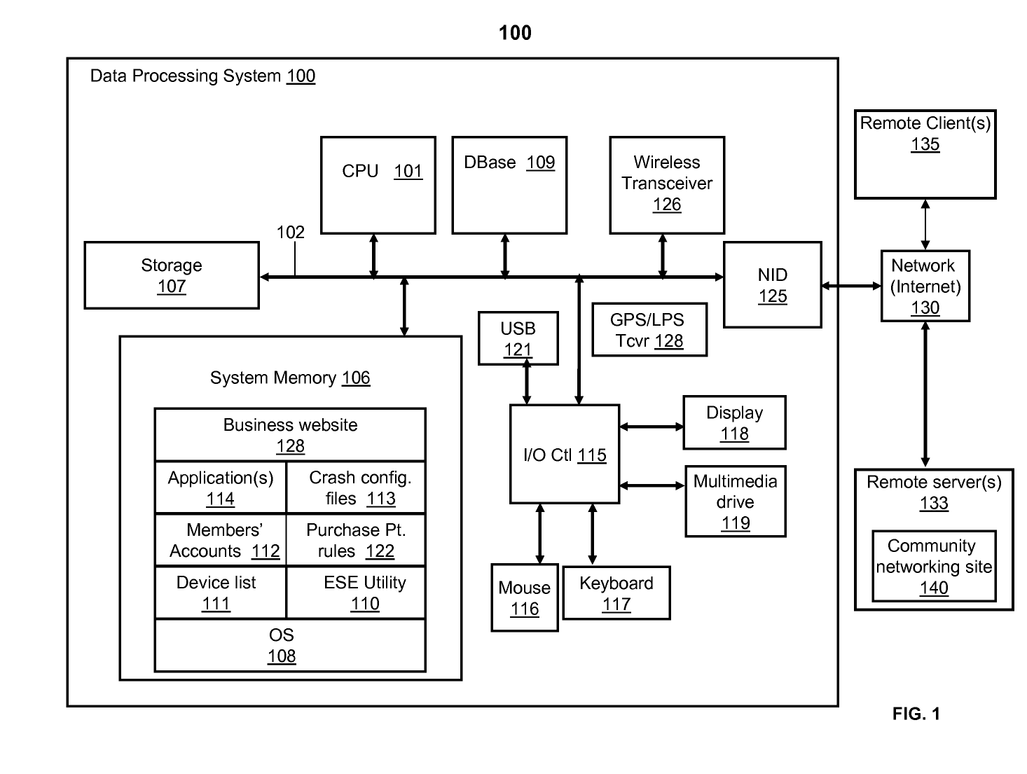

With reference now to the figures, and beginning with FIG. 1, there is depicted a block diagram representation of an example data processing system (DPS), as utilized within one embodiment. DPS may be a server, a personal computer, a portable device, such as a personal digital assistant (PDA), a smart phone, and/or other types of electronic devices that may generally be considered processing devices. As illustrated, DPS 100 comprises at least one processor or central processing unit (CPU) 101 connected to system memory 106 via system interconnect/bus 102. Also connected to system bus 102 is input/output (I/O) controller 115, which provides connectivity and control for input devices, of which pointing device (or mouse) 116 and keyboard 117 are illustrated. I/O controller 115 also provides connectivity and control for output devices, of which display 118 is illustrated. Additionally, a multimedia drive 119 (e.g., compact disk read/write (CDRW) or digital video disk (DVD) drive) and USB (universal serial bus) port 121 are illustrated, coupled to I/O controller 115. Multimedia drive 119 and USB port 121 enable insertion of a removable storage device (e.g., optical disk or “thumb” drive) on which data/instructions/code may be stored and/or from which data/instructions/code may be retrieved. DPS 100 also comprises storage 107, within/from which data/instructions/code may also be stored/retrieved. Database 109 is also connected to system bus 102 of DPS 100, within/from which business intelligence data and patrons' account information may also be stored/retrieved.

DPS 100 is also illustrated with wireless transceiver 126, which may receive and transmit signals from/to display monitors and receivers located in an environment that is within a wireless range of wireless transceiver 126. Also included within DPS 100 is LPS/GPS transceiver (Tcvr) 128, which includes required LPS/GPS Tcvr utility for local and/or global positioning operations as described herein. To further enable external network connection, DPS 100 also includes network interface component (NIC) 125, by which DPS 100 may connect to one or more access/external networks 130, of which the Internet is provided as one example. In this implementation, the Internet represents/is a worldwide collection of networks and gateways that utilize the Transmission Control Protocol/Internet Protocol (TCP/IP) suite of protocols to communicate with one another. NIC 125 may be configured to operate via wired or wireless connection to an access point of the network. Network 130 may be an external network such as the Internet or wide area network (WAN), or an internal network such as an Ethernet (local area network—LAN) or a Virtual Private Network (VPN). Connection to the external network 130 may be established with one or more servers 133, which may also provide data/instructions/code for execution on DPS 100, in one embodiment. In one embodiment, social/community networking site 140 is illustrated within server 133. DPS 100 may also connect to one or more remote clients 135 via network 130. While a locally connected database, Database (Dbase) 109, is illustrated, it is further appreciated that the database may also be located across a network 150 and be distributed, in alternate embodiments.

In addition to the above described hardware components of wireless system 100, various features of the invention are completed/supported via software (or firmware) code or logic stored within memory 106 or other storage and executed by Processor 101. Thus, for example, illustrated within memory 106 are a number of software/firmware/logic components, including Internet/website based application 114, which may include a web browser, business/establishment website 128, members/patrons account data 112, and device list 111. In one embodiment, members/patrons account data 112 includes membership information, selected options and preferences, payment information (credit card, etc.) and other information. Also in one embodiment, members/patrons account data are stored in DBase 109. In addition, memory 106 comprises special event/crash configuration files 113 and Interactive Stock/Social Exchange (ISE) logic/utility 110, which may interchangeably be referred to as Entertainment Social Exchange utility, in alternate embodiments. In actual implementation, ISE logic/utility 110 may be combined or with or integrated within another application or utility to provide a single executable component, which collectively provides the various functions of each individual component when the corresponding combined component is activated. For simplicity, ISE utility 110 is illustrated and described as a stand alone or separate logic/utility/firmware component, which provides specific functions, as described below.

In one embodiment, server 133 represents a software deploying server, and DPS 100 communicates with the software deploying server (133) via network (e.g., Internet 130) using network interface device 125. Then, ISE utility 110 may be deployed from/on the network, via software deploying server 133. With this configuration, software deploying server performs all of the functions associated with the execution of ISE utility 110. Accordingly, DPS 100 may not be required to utilize internal computing resources of DPS 100 to execute ISE utility 110. Also, in one embodiment, certain functional aspects of the ISE utility, such as and including those features related to local user operations/interactions may be downloaded to a mobile device via wireless download or some of method of loading the functional code on to the mobile device. As utilized herein, the terms mobile device and mobile phone are presented to represent any generally portable device that may be utilized by a user/patron to complete one or more of the user-related processes described herein. A non-exclusive list of such devices includes cell phones, iPods®, iPads®, mobile computers, personal digital assistants (PDAs), and the like.

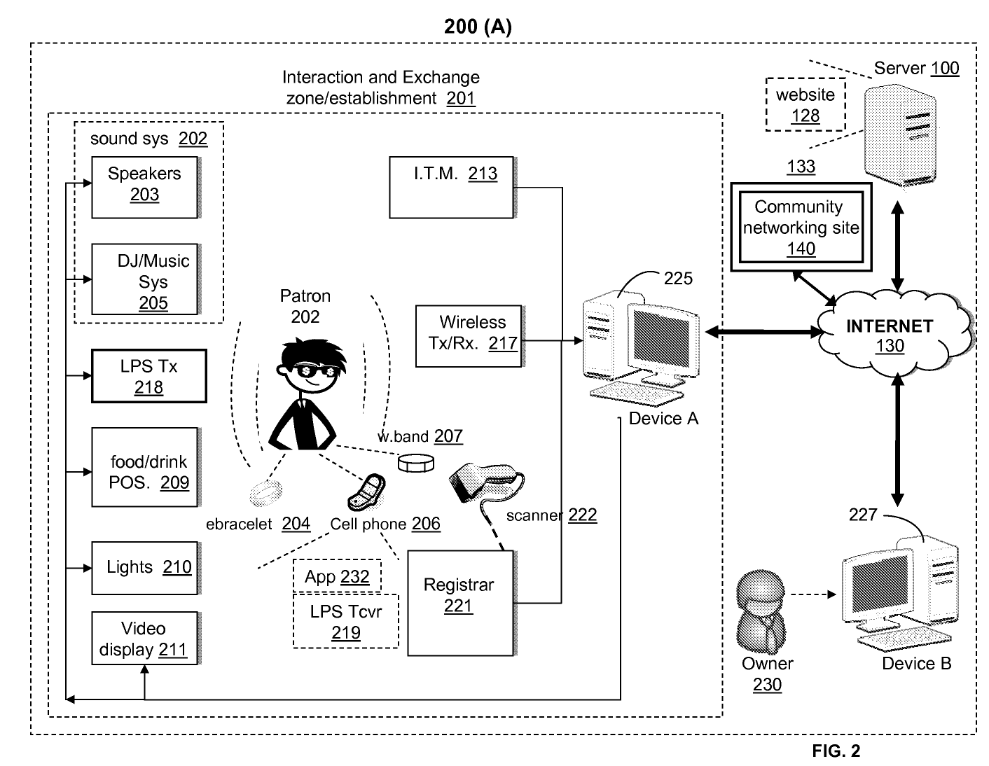

Certain of the functions supported and/or provided by ISE utility/logic 110 are implemented as processing logic (or code) executed by processor 101 and/or other device hardware. Among the software code/instructions/logic provided by ISE logic 110, and which are specific to the invention, are: (a) logic for configuring an electronic device to enable an individual to use the electronic device to initiate actions including item transactions and interactions with other individuals; (b) logic for registering the individual for access to an electronically configured establishment with authorization to initiate one or more of: (i) item transactions; and (ii) interactions with other individuals; (c) logic for triggering an initiation of a special transaction and interaction event; (d) logic for pre-selecting temporary target prices which are applied to one or more items during the special event; (e) logic for modifying item prices from standard prices towards the temporary target prices based on one or more of: (i) volume of sales of corresponding items; and (ii) time/schedule parameters; (f) logic for when the temporary target price is reached, triggering an item “crash” period/event in which patrons are able to purchase particular items at discounted prices; and (g) reporting selected information about transactions interactions to a community networking website. According to the illustrative embodiment, when Processor 101 executes ISE logic 110, DPS 100 initiates a series of functional processes that enable the above functional features as well as additional features/functionality. These features/functionalities are described in greater detail below within the description of FIGS. 2-15.

Those of ordinary skill in the art will appreciate that the hardware components and basic configuration depicted in FIG. 1 may vary. The illustrative components within DPS 100 are not intended to be exhaustive, but rather are representative to highlight essential components that are utilized to implement the present invention. For example, other devices/components may be used in addition to or in place of the hardware depicted. The depicted example is not meant to imply architectural or other limitations with respect to the presently described embodiments and/or the general invention. Additionally, DPS 100 may be a personal computer or a server, including a local or remote business computer/server, depending on the specific ISE functions that are being performed. In one embodiment, DPS 100 is a distributed system that includes a collection of several different types of devices, each performing a different function within the overall system. Within this embodiment, only certain functionality of ISE utility specific to the particular device need be executed on that device of the general system, while other functionality of ISE utility are provided by other devices within the system.

With reference now to FIG. 2, an example electronically and interactively configured social environment/network equipped with a dynamic item exchange/transaction and interactive activities reporting system is illustrated, according to one embodiment. Entertainment/social environment 200 comprises Interaction and Exchange (IE) zone 201. IE zone 201 comprises device-A/DPS 225 which is connected to a set of devices and/or components within IE zone 201. In one embodiment, DPS 225 is a client server which is connected to server 100. Included within the set of devices and components are registrar 221, Interactive Transaction Machine (ITM) 213 and sound system 205. IE zone 201 further comprises food/drink point of sales (POS)/cashier system 209. Also included within IE zone 201 are lighting (effects) system 210 and video display/monitor 211. Additionally, IE zone 201 includes wireless transceiver 217 and Local Positioning System (LPS) 218, which operates as a transceiver in conjunction with one or more LPS receivers 219 to enable patrons/users to be located within a particular establishment or within a surrounding area of the patron/user. In one embodiment, the patron/user may utilize a specific LPS utility provided with the mobile device (cell phone 206) and/or downloaded from ISE website or other source. In addition, patron 202 is one of several patrons/customers which are located within IE zone 201. Entertainment environment 200 also comprises device-B 227 which is operated by owner/manager 230. Owner 230 is able to connect to server 100 via Internet 130. Also illustrated in entertainment environment 200 is remote server 133 which includes social/community networking site 140.

In entertainment environment 200, ISE utility 110 provides access to features and functions of ISE utility 110 via a website based application/web browser (e.g., application 114), in one embodiment. ISE utility 110 provides a user/customer/patron registration component to enable the registration of patron 202 via an on-premise registration or an automated online registration process. ISE utility 110 registers patron 202 for access to an electronically configured establishment (e.g., IE zone 201) with authorization to initiate one or more of: (i) item transactions; (ii) activities/interactions with other individuals; and (iii) reporting of activities/transactions. ISE utility 110 enables on-premise registration by processing information obtained from an identification (ID) card of patron 202. The ID information/data may be electronically read/scanned or manually entered into the application on data processing device (e.g., device-A 225) which is also connected to server 100. ISE utility 110 compares the ID data of patron 202 with ID data of authorized patrons/members within members' account data 112 stored locally on device-A 225 and/or remotely on server 100. If patron 202 is a member of establishment website 128 which represents IE zone 201 and/or a website-based network community (e.g., social networking website 140) which receives reports about the actions/activities of patron 202 from ISE utility 110/establishment website 128, ISE utility 110 continues to register patron 202 as an on-site/registered user who is linked via ID information to a corresponding member account of establishment website 128 and/or the website-based network community. In one embodiment, IE zone 201 is associated with one or more local websites (associated with website 128 and/or application 114) executing on DPS 225 and/or server/DPS 100. In addition, IE zone 201 may subscribe to a social networking website (e.g., social/community networking website 140) on a remote server (e.g., server 133).

In one embodiment, IE establishment 201 subscribes to social networking website 140 on which website members have individual accounts. The social networking site further consists of or may connect to sub-communities which may be accessible to members in a local area network and/or members with accounts on the social networking site. These sub-communities may represent the online presence of various businesses and/or entertainment facilities including fitness centers, restaurants, hotels/resorts, night-clubs, bars and other businesses or entertainment facilities (e.g., IE zone/establishment 201). Thus, in one embodiment, the various individual business websites (e.g., establishment website 128) may also subscribe as sub-communities to social networking website 140. In another embodiment, the establishment websites communicate information with social networking website 140, according to preset configuration settings. These sub-communities may grant access permission to members of social networking website 140 which members fulfill specific requirements. These network members may also create credit/financial accounts within these sub-communities and/or within social networking website 140 to enable these members to order/purchase products and services from the various businesses. Thus, members are able to sign into the account and order/purchase products and services locally (i.e., in person) or remotely. ISE utility 110 may allow a patron to configure the account to record/log all/select activities globally within the website-based network community and/or locally, within the sub-community which represents IE zone/establishment 201. In one embodiment, IE zone 201 is directly associated with website/application 128, application 114 and one or more other applications, which collectively reside on a first platform or first set of platforms. ISE utility 110 reports activities and/or transactions occurring on the first platform (or first set of platforms) to one or more of: (a) other applications within said first platform; (b) dependent applications/sub-applications; (c) separate/independent applications; and (d) independent applications within external/separate platforms.

Referring again to FIG. 2 and, in particular to the registration process (such as when patron 202 first enters the establishment or via the establishment's online registration process), patron 202 is given one or more of: (a) a non-electronic wristband (e.g., wrist-band 207) with a unique bar code; and (b) an electronic bracelet (e.g., e-bracelet 204) which contains a wireless transceiver. E-bracelet 204 may also contain a unique bar code. The unique bar code is scanned with scanner 222 of registrar 221 to link patron 202 to the one or more corresponding member's accounts. At registrar 221, e-bracelet 204 is initialized to enable one or more of: (a) automatic identification/detection of patron 202 by ISE utility 110; and (b) automatic detection of notification signals sent to patron 202. ISE utility 110 provides each patron with a unique ID and/or carrier frequency. Thus, e-bracelet 204 is initialized to utilize the unique ID and/or carrier signal in transmitting data to other electronic/wireless devices. DPS 225 is able to transfer status/notification data to patron 202 via e-bracelet 204 using the unique ID and/or carrier frequency. Other forms of uniquely identified components/devices may be utilized to identify one patron from another, including in one implementation a special unique code that is entered into an ISE application (app) on the patron's phone, which allows the phone to become a transceiver of specific location information and patron identifying information.

ISE utility 110 provides an automatic online registration process for patron 202. ISE utility 110 enables patron 202 to access a web-based establishment application (e.g., website 128) for the website(s) associated with IE zone 201 via an electronic/wireless device (e.g., cell phone 206). In one embodiment, ISE utility 110 enables patron 202 to access establishment website 128 via website browser/application 232. In one embodiment, App 232 includes local positioning system (LPS)/geographic/global positioning system (GPS) technology/applications. Cell phone 206 (or other electronic device of patron 202) may also comprise an LPS/GPS receiver. As described herein, an electronic device is one or more of: (a) a wired electronic device that uses a wired connection to access a data processing system (e.g., DPS 225); (b) a wireless electronic device that wirelessly connects to a data processing system (e.g., DPS 225); and (c) a data processing system (e.g., DPS 225). ISE utility 110 configures the electronic device to enable an individual (e.g., patron 202) to use the electronic device to initiate actions including item transactions and interactions with other individuals/patrons. ISE utility 110 enables authorized members of establishment website 128 to login and initialize cell phone 206 for entry to and use within the premises of IE zone 201. Similar to the initialization of e-bracelet 204, ISE utility 110 enables cell phone 206 of patron 202 to transmit and receive a unique ID and/or utilize one or more carrier signals in communicating data with DPS 225 via wireless transceiver 217 and/or with other patrons. In particular, ISE utility 110 may enable the transmission and detection of signals within IE zone 201 according to a radio technology and communication protocol particularly suited to communication between devices within the configured space/establishment of IE zone 201. For example, ISE utility 110 may provide data communication between devices by utilizing one or more of: (a) Bluetooth technology; (b) WiFi technology; (c) Short Message Service (SMS)/text messaging; and (d) radio-frequency identification (RFID).

In one embodiment, ISE utility 110 allows patron 202 to initialize cell phone 206 to respectively transmit an identification (ID) signal and a payment authorization signal to ID detector and automatic wireless payment/debit system while walking along designated signal detection registration lanes at the entrance of IE zone 201. ISE utility 110 enables a member/patron to configure a credit/purchase/order account on the establishment website representing IE zone 201 to transmit a payment authorization signal to enable wireless and electronic payment for products/services. When the payment authorization signal is detected by payment/debit/registrar system 221, the funds are automatically deducted from the member's account. Thus, ISE utility 110 enables an auto-login & auto-deduction procedure when the ID signal and the payment authorization signal are detected and the deduction of payment transaction is successful. Patron 202 enters the establishment via a fast/VIP lane. ISE utility 110 performs auto-deduction of points/credit/funds in a patron's credit/purchase/order account on establishment website 128. ISE utility 110 provides audio and/or visual notification of a status of the auto-deduction process (i.e., whether the process was successful or unsuccessful). ISE utility 110 may provide indication of a successful transaction by automatically sending a notification signal to cell phone 206/e-bracelet 204 in order to activate access granted notification lights. The patron (e.g., patron 202) may also be given a disposable ticket bracelet with a corresponding unique bar code or stamp to visibly confirm payment of entrance fee.

In one embodiment, ISE utility 110 registers individuals as a patron of the electronically configured establishment based on one or more of: (a) an authorization of the individual to access the electronically configured establishment; (b) authentication of the individual as a registered user of the establishment website; (c) authentication of the individual as a registered user of community networking websites (e.g., community networking website 140); (d) a linking of one or more online accounts of the individual; and (e) a configuration of the electronic device for use within the electronically configured establishment. In addition, ISE utility 110 may register individuals as one or more of: (a) an active patron; (b) an online patron; and (c) a standard/passive patron.

According to ISE utility 110, an active patron may be an individual who establishes one or more of: (a) a real presence in a particular establishment; (b) an online presence; (c) a social presence which indicates the individual (i.e., the real/actual presence of the individual) interacting with other individuals who also establish real presences in the particular establishment; and (d) a virtual presence. ISE utility 110 may designate an individual as an online patron based on one or more of: (a) access to establishment website from within IE zone 201; (b) remote access to establishment website; and (c) a virtual presence within IE zone 201. ISE utility 110 may designate an individual as a passive patron based on one or more of: (a) use of a non-electronic wristband within IE zone 201; (b) remote access to establishment website; (c) use of an e-bracelet within IE zone 201; and (d) use of establishment devices including ITMs and scanners to initiate activities in IE zone 201. ISE utility 110 enables the individual to establish said real presence according to one or more of: (a) receipt of an ID signal transmitted by the individual which enables detection of the real presence of the individual; (b) an authentication of the individual within the particular establishment to authorize one or more activities of the individual; and (c) other ways of demonstrating that said particular individual is detected as a real presence in the particular establishment. In one embodiment, ISE utility 110 enables the individual to perform actions according to one or more of: (a) status as an active patron; (b) status as an online patron; (c) status as a standard/passive patron; (d) the real presence; (e) the online presence; (f) the social presence; and (g) the virtual presence.

In one embodiment, ISE utility 110 initiates special activities/transaction and interaction events. ISE utility 110 may dynamically display item information including item prices for items that are transacted in IE zone 201/establishment website 128. ISE utility 110 may display item information via one or more display formats on one or more display monitors. ISE utility 110 may dynamically modify item prices based on the volume/level of transactions/revenues corresponding to items and/or time/scheduling parameters. ISE utility 110 may dynamically select items for which information is displayed on a display monitor based on one or more of: (a) a volume/level of transactions/revenue corresponding to items; (b) place of items in a display waiting queue; (c) pre-existing agreement pertaining to items; and (d) manager's discretion. ISE utility 110 may provide multiple display formats including an item ticker which is shown via one segment of the display monitor. ISE utility 110 may display item information in a ticker format concurrent with a viewing of television programs or other recorded programs. ISE utility 110 may provide transaction procedures which may particularly apply to particular events. ISE utility 110 detects an initiation of one or more of: (a) item transactions including transactions pertaining to the special transaction event; and (b) interactions with other individuals (during and pertaining to the special transaction event).

In one embodiment, ISE utility 110 provides patron 202 with access to a transaction and interaction component/application stored on one or more data processing devices (e.g., DPS 100/DPS 225) via a wireless device (e.g., cell phone 206). ISE utility 110 enables patrons to set up member accounts on establishment website 128 and/or community networking website 140 to provide access to communication and online transactions via an electronic/wireless device connected to the LAN. In one embodiment, however, a patron without a website-based member account on social networking site 140 may only utilize some of the features and functionality of ISE utility 110. In one embodiment, ISE utility 110 may perform functions according to (a) data from a patron's account on establishment website 128, (b) financial credit within an account linked to the patron's account on establishment website 128 and (c) data from other accounts linked to patron 202 and establishment website 128. Patron 202 may access account information by using application 232 on a cell phone. For example, the owner of the cell phone may choose to purchase points/credits/e-beads for use within IE zone 201. ISE utility 110 executing on a server/data processing device (e.g., DPS 225) within IE zone 201 keeps track of all points/credits/e-beads within member accounts on establishment website 128. ISE utility 110 provides periodic notification to respective wireless devices connected to the LAN of the number/amount of points/credit/e-beads a respective cell phone owner (i.e., a patron) has in a member account on establishment website 128.

ISE utility 110 allows the patron to access the member account on establishment website 128 via application 232. The patron may also have an account on social networking site 140. In transactions involving member accounts/account data associated with establishment website 128, ISE utility 110 enables a first patron to transfer points/credits/e-beads to a second patron via direct signaling between a pair of wireless devices (e.g., via RFID, Bluetooth®, or other short range device to device signaling method). ISE utility 110 may report activity detected within the LAN/IE zone 201 to the member account (of the patron) within social networking site 140. ISE utility 110 enables the patron to link multiple/both accounts of the patron, i.e., the member account on establishment website 128 and the member account on social networking site 140 and transfer points/credits/e-beads from one account to the other. ISE utility 110 enables a patron/member to pre-select the amount of credit/points that the patron/member wishes to utilize within a specified period of time at IE zone 201. For example, a patron may set a maximum budget for transactions/activities within IE zone 201.

ISE utility 110 enables a patron to specifically configure the accounts to enable a first action detected within the LAN/IE zone 201 to trigger a second action in the member account of the patron within social networking site 140. For example, when the first patron who is located within IE zone 201 transfers points/credits/e-beads to another/second patron who is also located within IE zone 201, ISE utility 110 may trigger a function provided by DPS 225 to determine whether patron 202 has an online friendship with another individual on one or more social networking websites (e.g., community networking website 140). ISE utility 110 may trigger a friend request from the first patron to the second patron within social networking site 140 when the first patron does not have an online friendship with the other individual/patron on the one or more social networking websites. In addition, ISE utility 110 may perform one or more of: (a) initiation of online event invitations; (b) initiation of invitations to join online groups; (c) an initiation of an upload of photos or videos of patrons involved in a transaction; (d) other features provided by establishment website 128; (e) other features provided by community networking website application 140; and (f) automatic updates to information about activities of individuals in the electronically configured establishment.

In one embodiment, ISE utility 110 may also trigger a friend request from the first patron to the second patron within social networking site 140 when neither the first patron nor the second patron are located within IE zone 201 and one or both patrons are instead remotely logged into establishment website 128. ISE utility 110 detects the initiation of the friend request in social networking site 140 and enables the second patron to quickly and efficiently accept the friend request, via establishment website 128 or another application. ISE utility 110 enables certain pre-configured functions provided by social networking site 140 to be activated remotely by functions provided by establishment website 128. In one embodiment, ISE utility 110 allows an action in social networking site 140 to trigger an action in the account on establishment website 128 when the originating action was initiated in the account on establishment website 128. For example, when ISE utility 110 receives notification that the second patron accepted the friend request, ISE utility 110 may proceed by completing the current (transfer) transaction that is previously halted to initiate the friend request. In one embodiment, ISE utility 110 completes the transaction that is previously halted following receipt of one of: (a) notification of acceptance of the request for online friendship; and (b) notification that the first patron/individual issued the friend request to the other individual; and (c) notification of a pre-existing online friendship between the individuals. ISE utility 110 allows a patron to transact points/credits/e-beads and interact via the local/establishment website by using one or more of: (a) a cell phone; (b) an ITM; and (c) other electronic/wireless devices.

ISE utility 110 provides a patron/user with multiple inter-network and intra-network communications options. ISE utility 110 enables a patron to communicate using a single electronic/wireless device via one or more of: (a) a telephone network; (b) a wide area network (WAN), e.g., the Internet; (c) a local area network (LAN); and (d) a personal area network (PAN). In one embodiment, the LAN represents IE zone 201. ISE utility 110 enables a patron to communicate transaction messages within IE zone 201. In addition, ISE utility 110 enables a patron to establish a PAN for communicating with a specific group of friends while present in IE zone 201. The PAN may utilize Bluetooth and/or WiFi technology. Prior to the completion of one or more stages of the transaction process (e.g., confirmation of order receipt, bid acceptance or transaction completion) within the LAN, ISE utility 110 enables a patron to configure notification options to enable the patron and friends within (i.e., connected to) the PAN to receive notification about the completion of a transaction stage. Thus, upon completion of one or more stages of the transaction process, ISE utility 110 may notify the patron via a notification message based on transactions occurring in the LAN. According to a preset notification configuration, when ISE utility 110 receives an acknowledgement message that indicates that the patron receives the notification message, ISE utility 110 triggers the transmission of a preset broadcast notification message from the patron to the friends within the PAN. For example, the patron may broadcast the following text message: “Hey guys, bottle service is ready. Let's meet at our table immediately!” ISE utility 110 allows a user/patron to configure message delivery settings to enable transaction, interaction and notification messages on the various networks to be delivered using distinguishable/unique alerts. In one embodiment, ISE utility enables the patron to pre-select “friends” to who the message is to be communicated. The selection of specific friends may be via the online website (linked to the social media application), such as for example, everyone in a personal group called “club-buddies”. In one embodiment, the patron may create the list of friends at the local establishment computers when the patron arrives at the establishment or before from an online access to the establishment's website. With this select notification messaging process, the patron is able to provide a real-time update (as with a Twitter® account) of events that are occurring that are related to the patron and his friends. As an example, the patron's online social media application (of which the patron is a member) may also receive a notification that is then published on the patron's personal page (e.g., “Hanging out at Club X. Just got bottle service for my club-buddies for $50.00 per bottle.”)

ISE utility 110 automatically reports pre-selected LAN-based activities and PAN-based activities to the online member accounts (e.g., within a social networking community) of the patron and the friends via the WAN/Internet, according to preset user configurations. ISE utility 110 may report information about the actions/activities of patron 202 which information includes one or more of: (a) identification of patron 202; (b) identification of other individuals associated with the action; (c) identification of the action; (d) transaction data; and (e) interaction data. ISE utility 110 may enable patron 202 to initiate communication with another patron based on one or more of: (a) text message; (b) cell phone call; (c) voicemail; (d) instant message; (e) video call; and (f) direct signaling between respective devices. ISE utility 110 may enable patron 202 to allow friends within the PAN and/or other online friends to monitor communications via one or more of: (a) an application on an electronic device; (b) an application on a remote server; and (c) community networking website application 140. In addition, ISE utility 110 enables a member to configure several unique PANs to communicate with various friends and/or groups of friends within a LAN. Similarly, according to preset user configurations, these reports may be provided as privately displayed messages or publicly displayed messages within a member's online account.

When executing within a wireless/mobile device, such as a cell phone, ISE utility 110 enables patron 202 to use cell phone 206 to begin transmitting (a) an information signal which contains the ID of patron 202 and/or (b) a permission signal to enable payment to be automatically deducted from the account of patron 202. In one embodiment, ISE utility 110 enables patron 202 to access establishment website 128 and/or other linked financial accounts to send a payment authorization from the relevant account of patron 202 (on establishment website 128 or another account linked to establishment website 128) to establishment website 128 to provide payment to the entertainment establishment represented by establishment website 128. ISE utility 110 enables patron 202 to configure a payment schedule which allows the entertainment establishment to deduct payment via establishment website 128 when patron 202 is detected via an ID signal and the payment authorization is received. ISE utility 110 may transmit an ID signal and an auto-deduction permission signal while cell phone 206 is concurrently used for calls, texts, emails, and other functions. Thus, if patron/member ID signal and auto-deduction permission signal transmissions are initiated, patron 202 is able to walk into IE zone 201 while having an un-interrupted phone conversation. Patron 202 may establish personal guest lists via application functions to provide friends with pre-paid access to the establishment. ISE utility 110 may provide other application functions including a function which enables patron 202 to establish a bar tab which is linked to his purchasing/credit account. In one embodiment, ISE utility 110 automatically sends notification/indication to friends of patron 202 when patron 202 places friends on a guest list of patron 202 before these friends enter IE zone 201. ISE utility 110 may allow a patron to establish/increase credit/purchasing power by enabling the customer/patron to swipe a credit card and link the credit card to the corresponding barcode on the bracelet and ultimately to a member's account. The patron may utilize an ITM to increase the credit within the account. ISE utility 110 may prevent a patron from leaving IE zone 201 in possession of an e-bracelet by detecting a device alert signal at a checkout register at the exit of IE zone 201. ISE utility 110 may provide an audio and/or visual notification to an operator at the checkout register.

In one embodiment, ISE utility 110 enables the establishment of a point/bead/token system by which points/beads/tokens may be purchased or received as a special promotion/sponsor's gift. ISE utility 110 allows a user to purchase/obtain items/drinks/food based on points within the member's credit account. The points/beads may be tracked through a barcode or via a transmitted radio signal. ISE utility 110 enables patron 202 to use cell phone 206 to purchase food/drinks. For example, Patron 202 may be seated at a VIP table and makes an online order via cell phone 206 for bottle service (i.e, patron 202 orders a bottle of a preferred beverage). ISE utility 110 allows patron 202 to download an establishment menu/drink list showing items and prices from which to make an order request. When ISE utility 110 detects receipt of the order, ISE utility 110 designates the order as a pending order. ISE utility 110 also receives indication that patron 202 wants the costs to be deducted from his member account. ISE utility 110 verifies an availability of sufficient credit/points/funds before filling the order. The order is filled and ISE utility 110 designates the order as filled. A waitress is dispatched to the location of patron 202 at a known/designated VIP table location. The waitress provides patron 202 with the bottle service. Patron 202 signs a receipt to complete the transaction. In addition, patron 202 may be expecting several friends to arrive within a particular time interval, for example, 30 minutes. ISE utility 110 enables patron 202 via a website application to establish a personal guest-list for friends. Using the personal guest-list of patron 202, friends of patron 202 may enter IE zone 201, and pre-set amount of points (which may be directly tied to a credit card charge or other payment method) may be automatically deducted from the account of patron 202. The utility may also provide notification to the guests/friends of the location of the patron 202 within the establishment.

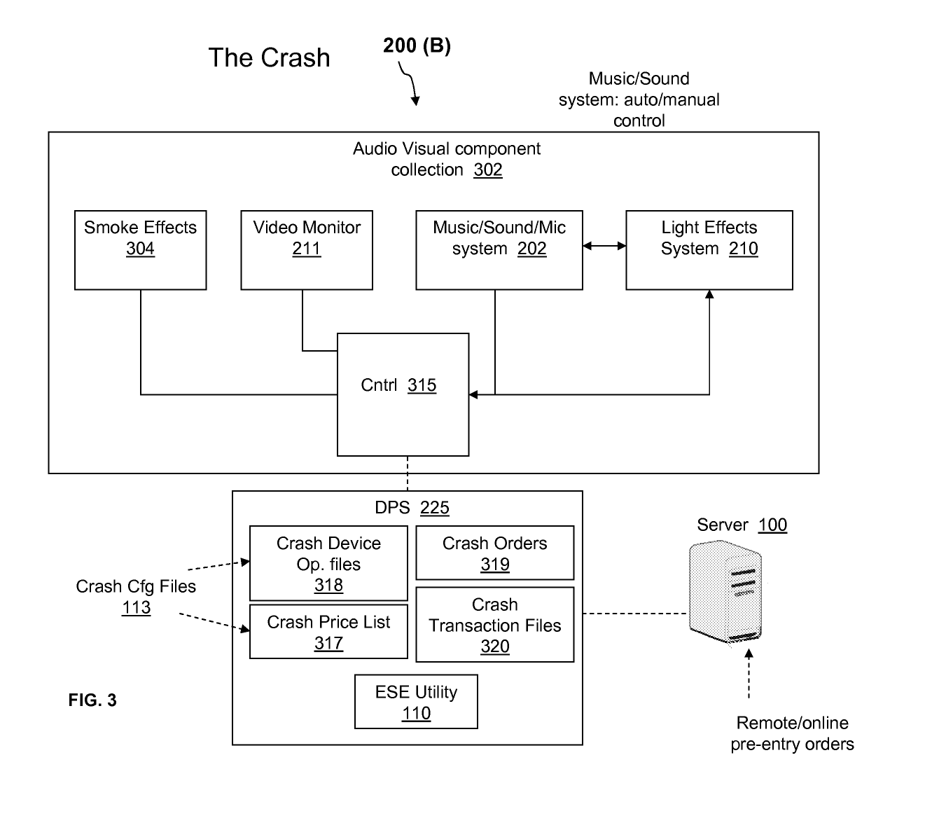

ISE utility 110 may award points to a patron for specific levels of purchases. For example, ISE utility 110 may award patron 202 with twenty (20) item purchase points, according to purchase point rules 122, for purchases made thus far (e.g., for spending/utilizing over 300 points). At tonight's celebration, patron 202 expects the group of friends to consume several bottles. Thus, patron 202 places a few bid orders (described in FIG. 3) for 4 more bottles and patiently awaits an item price crash. In one embodiment, to avoid the over-consumption of alcohol (or other consumable product) because of the low purchase costs during a crash, the ISE utility may monitor the amount of consumable product being consumed by the particular patron (or the patron's group of friends) and prevent that particular patron from ordering additional amounts of the consumable product, particularly when other patrons are also bidding for the same product. This prevents a single patron from receiving the entire benefit of a crash by purchasing the entire amount of consumable product at the crash price.

In one embodiment, ISE utility 110 enables a patron to actively and interactively participate in product/service and business advertising. In one embodiment, ISE utility 110 reports information about an individual's activities in IE zone 201 community networking website 140. ISE utility 110 translates the information about actions/activities initiated by the individual into advertising content. ISE utility 110 enables users/patrons to report activities in IE zone 201 by using one or more of: (a) simple text; (b) hypertext links; (c) product/service and business logos; (d) voice/speech. For example, patron 202 is able to report on a member's activities page within a social networking website that patron 202 received “silver moose” “bottle service” at “entertainment establishment” using a “bid order” on “date1”. ISE utility 110 enables the report to be displayed on pages of the friends of patron 202. When the report involves one or more of the friends of patron 202, ISE utility 110 may also display the report on the respective activities pages of these friends. In addition, ISE utility 110 may display the report on the respective activities pages of the “friends of the friends” of patron 202, who may largely represent a group of members who have one or more degree of separation from an online friendship with patron 202. ISE utility 110 may provide reports and/or reports in the form of advertising content on members' activities pages according to a preset number of degrees of separation of online friendship. As a result, advertising content involving a first member may be displayed on website pages of a second member. For example, if patron-Jennifer is friends with patron 202 and patron-heather, but patron-heather is not friends with patron 202. Thus, the connection between patron-heather and patron 202 is defined as having 1 degree of separation. Given a preset configuration of 1 degree of separation, activities by patron 202 may be displayed on a member page(s) of patron-Heather. Thus, ISE utility 110 provides multiple instances of the advertising content being displayed in order to effectively/efficiently promote products/services and businesses, according to a multiplier advertising mechanism.

ISE utility 110 allows interested members to enjoy an experience similar to the experience of patron 202 and his friends (i.e., as described within the reports displayed within multiple members' pages). For example, the hypertext link “bid order” may enable a user to place a bid for specific dates for one or more particular products within various entertainment facilities including IE zone 201. Thus, ISE utility 110 encourages users to use/reuse the same effective media of product/service and business advertising to purchase the products/services and businesses that are being advertised and to further expand/increase the multiplier advertising effect. ISE utility 110 enables owners/managers to provide even greater incentives to users/patrons/members to purchase and/or provide reports with advertising content by providing a reward/pay incentive mechanism. For example, managers may provide patrons with incentives through the use of “event” points that may be valid for a particular event and/or time period. Thus, patrons are encouraged to go to IE zone 201 to utilize these points before the points expire.

In addition, ISE utility 110 may provide, for example, a reward/points/credit/pay per click/order incentive program. Thus, a patron is encouraged to invite real-life friends to join particular social networking sites and to celebrate in larger groups with well connected friends in select establishments. ISE utility 110 may allow a manager/owner of a business establishment to track (a) members who have triggered and/or participated in activities which enabled the placement of advertising content and (b) the amount of advertising content placed by the respective members. By linking patron 202 to an online user ID/account, ISE utility 110 also enables managers/promoters to track patrons/members through (a) the establishment website of IE zone 201 based on level of purchases, point accumulation, frequency of visits, home zip code and other differentiating characteristics and (b) social networking website 140 according to reported activities. Managers/promoters may also send out emails and special promotions to patrons. The owner/manager is able to provide points/credit to users/members based on the level and impact of the corresponding advertising content. Thus, ISE utility 110 provides an efficient, powerful and lucrative viral marketing mechanism by enabling social networking communities to actively and interactively participate in the advertisement and sales associated with various products, services and business establishments.

ISE utility 110 provides a manager/owner with critical business evaluation data. ISE utility 110 may enable the manager/owner to retrieve data from social networking website 140 according to particular categories. In one embodiment, ISE utility 110 creates specialized categories of demographic groups based on one or more of: (a) information about actions reported; (b) a preset group of categories associated with a range of actions reported by a particular business/establishment; and (c) pre-arranged set of categories pertaining to a particular type of business and business activities associated with information in respective reports.

ISE utility 110 identifies patrons/individuals as group members of said specialized categories of demographic groups based on the reported activities of members. ISE utility 110 compiles population lists for the specialized categories of demographic groups according to recorded activities of patrons/members. Thus, ISE utility 110 is able to identify a target audience who has demonstrated by activity a particular level of interest in a product/service.

ISE utility 110 determines an affinity factor for a level of association a member has with a particular item/service/event/place, based on the patron's reported activities. For example, if patron 202 parties every week at IE zone 201 and often orders vodka through bottle service, ISE utility 110 assigns to patron 202 a high affinity factor (e.g., a rank of 8 out of a possible 10) for each of the following: (a) going to nightclubs; (b) ordering bottle service; and (c) purchasing vodka. ISE utility 110 may identify a patron's/member's preferred night for entertainment based on registration records and calculate a corresponding affinity factor. ISE utility 110 may be able to characterize a patron's network of friends by various categories including advertising ability and buying/selling ability, based on guest-list records, electronic bar tabs, transaction records and publicly displayed messages. ISE utility 110 dynamically updates the respective affinity factor when a new instance of a reported activity associating the member with the particular product or service is identified. Thus, ISE utility 110 enables a selection of target audience by the affinity factor. Furthermore, ISE utility 110 enables a selection of target audience according to a specified level of affinity factor for multiple products/services, respectively. For example, ISE utility 110 includes patron 202 within a population list of persons who “frequently” go (i.e., with an affinity factor of 7 or higher) to nightclubs and “frequently” order bottle service. ISE utility 110 enables an advertiser to granularly select the target audience in order to forward advertising content to the target audience selected. Thus, ISE utility 110 enables enhanced target audience identification (ETAI) based on the compiled population lists and the corresponding affinity factor.

ISE utility 110 also determines an association/causal factor for a level of association of a pair of activities/characteristics/aspects. For example, since patron 202 frequently attends nightclubs and orders bottle service, patron 202 is included within a population list of persons who demonstrate a high association/causal factor (i.e., with an association factor of 8 or higher) for attending nightclubs and ordering bottle service.

In one embodiment, ISE utility 110 determines a “recency” factor for a level of recent activity that associates a member/patron with the particular item or service. In particular, the recency factor provides a measure of the level of a particular activity within a specified time period. ISE utility 110 dynamically updates the recency factor when a new instance of a reported activity and/or less recent activities which are previously used to determine the recency factor are removed as components in the determination of the current measure of the recency factor. In one embodiment, ISE utility 110 calculates the recency factor based on a simple moving average or a weighted moving average. ISE utility 110 enables a selection of target audience based on one or more of: (a) the affinity factor; (b) the causal factor; and (c) the recency factor. ISE utility 110 facilitates an efficient marketing and advertising process by providing a business proprietor with targeted information based on audience activities with respect to a particular product/service/establishment.

ISE utility 110 enables the manager of IE zone 201 to review via the establishment website the sales performance of items sold at a previous event, for example, a Mardi Gras event. ISE utility 110 allows the manager to identify the best buyers, the corresponding favored items and the best advertising members to provide appropriate member/patron incentives as the manager diligently works to repeat the success of the previous Mardi Gras event. In addition, ISE utility 110 enables a manager to forecast expected performance/success/revenues of future events and to plan accordingly. If ISE utility 110 indicates that a high number of bid orders have already been placed for a particular product, the manager may acquire more of that particular product for a future event. If ISE utility 110 provides a forecast which indicates an average turnout for a future event, the manager may strategically provide added point/item incentives to a particular set of valued patrons. The manager may also re-introduce a particular winning event preferred by the patrons that the manager is hoping to attract to IE zone 201. In particular, ISE utility 110 provides the forecast of expected interest/performance/success/revenues of future events based on one or more of the following forecast indicators: (a) RSVP notifications; (b) pre-orders including bids; (c) a level/volume of item trading; (d) observed trends; and (e) other forms of pre-event notifications.

ISE utility 110 enables a website administrator to place customized and targeted advertisements on the general advertising space on the online pages of selected members. ISE utility 110 enables the placement of advertisements which are customized and targeted according to one or more of: (a) a member's name; (b) a member's user ID; (c) a member's recent activities; and (d) other activities associated with a particular member.

ISE utility 110 enables a patron via application 114 to define a new product based on one or more of: (a) product name; (b) particular product composition; (c) associated event; (d) target price; and (e) other product parameters. ISE utility 110 forwards information about the new product/service/event to a product development manager for e.g to evaluate said new product for one or more of: (a) sales approval; (b) implementation approval; and (c) an approval corresponding to a particular request within said information about said new product/service/event transmitted. ISE utility 110 enables the product development manager to send a decision notification to the patron. The decision notification provides information pertaining to one or more of: (a) final product composition; (b) new product price(s); and (c) associated events at which permission is granted for new product/service to be sold/implemented. When information pertaining to the decision notification is recorded in an appropriate application (e.g., application 114), ISE utility 110 transmits a report containing information about the new product/service to one or more of: (a) an online website application/server; (b) a community networking website application/server; (c) other local applications (i.e., applications on a same/local platform); and (d) other remote applications. ISE utility 110 enables the new product to be reported/advertised according to a specific schedule.

Following identification of the target audience based on audience activities, ISE utility 110 enables the business manager to inspect/group the target audience selected according to other/passive demographic/psychographic filters which are based on the information an audience member manually self-reports and/or is not generally based on activity. These passive demographic filters may include one or more of the following filters, among others that may be defined within the particular application of ISE utility: (a) age; (b) gender; (c) education; (d) career; and (e) interests, et al.

Although ISE utility 110 is described from the perspective of an implementation within an entertainment establishment/business/industry, ISE utility 110 may also be implemented within environments relevant to various other industries. For example, ISE utility 110 may be implemented in the health care industry, at trade shows, in applications pertaining to information technology, activity tracking within a manufacturing process, home entertainment and game applications, applications in the gaming industry, the banking industry, retail applications and in numerous other applications. In addition to social/community networking website applications, ISE utility 110 may report data/information to other applications which store dynamic data. For example, ISE utility 110 may report to a database application in which records are stored. ISE utility 110 may report, update, modify and/or add information to these records within one or more database(s).

FIG. 3 illustrates an example electronically configured commercial/entertainment establishment during an item price crash which represents a special transaction/interaction event, according to one embodiment. Entertainment environment 200 comprises audio-visual (entertainment component/device) collection 302 which is connected to DPS 225. DPS 225 is also connected to server 100. Audio-visual collection 302 comprises one or more components including lighting (effects) system 210, video display/monitor 211, music/sound system 205 and smoke effects system 304. The individual components of audio-visual entertainment component/device collection 302 are connected to controller 315. DPS 225 comprises several crash configuration files including crash device operating files 318, crash price list 317 and crash orders 319. Crash transaction files 320 are also included in DPS 225. In addition, DPS 225 includes ISE utility 110.

Prior to an item crash, ISE utility 110 enables patron 202 to place bid orders for selected items. The bid is placed for an item at a crash price (i.e., the temporary target price) or at a price between the standard item price and crash price. ISE utility 110 may fill the bid order based on one or more of but not limited to: (a) the total cost of the order; (b) the difference between the current item price and the bid price; (c) the difference between the current item price and the crash price; and (d) the interval between the current time and closing time.

ISE utility 110 triggers an item crash event based on one or more of: (a) a preset schedule; (b) random interval selection; (c) volume of sales of an item; and (d) a spontaneous manual trigger (e.g., a manager's discretion). When ISE utility 110 triggers a crash, ISE utility 110 provides an audio-visual show, according to crash device operating files 318. In one embodiment, bells ring via music/sound system 205. Smoke is generated by smoke effects system 304 and spreads throughout the air. A vivid light show begins via light effects system 210 and a crash signature tune plays via music/sound system 205. In addition, video monitor 211 may provide vivid notification of the crash. Crash items and prices are displayed. The time remaining before the crash period ends is highlighted. The DJ encourages/rallies the patrons via music/microphone/sound system 205 to “sink the bar”.

ISE utility 110 reduces the price of one or more items or services, according to crash price list 317. In one embodiment, ISE utility 110 may double the value of a patron's points if the patron buys featured items or buys at certain times (e.g., during a crash) within a particular time period. ISE utility 110 places IE zone 201 into crash mode for a preset time period. For example, ISE utility 110 may establish a crash mode for a period of about 7 minutes or the duration of two songs. ISE utility 110 fills the order for the relevant items for patron 202. In addition, ISE utility 110 sends audio/visual/vibrating notification to patron 202 that an order is filled via a cell phone, for example. In one embodiment, ISE utility 110 automatically sends a text to cell phone 206 of patron 202. ISE utility 110 may also trigger a vibrate sequence within cell phone 206. In general, patrons may submit orders for items at crash prices (or other prices) by one or more of: (a) online ordering via a wireless device (e.g., cell phone 206); (b) a bar order; (c) a waiter/waitress order; and (d) remote online ordering/purchasing to pre-pay for items before a patron's arrival in IE zone 201. ISE utility 110 may send notification to remote members to inform these members of the onset of a crash in IE zone 201. ISE utility 110 records/logs orders via crash order files 317 on DPS 225. Similarly, ISE utility 110 records/logs member transactions including crash related transactions of individual members/users in the respective member's online account.

In addition to being/providing an exciting audio-visual show, the crash also encourages a more exciting atmosphere of interaction and transactions within IE zone 201. These interactions include patron-patron interaction, patron-staff interaction and patron-ITM device interaction.

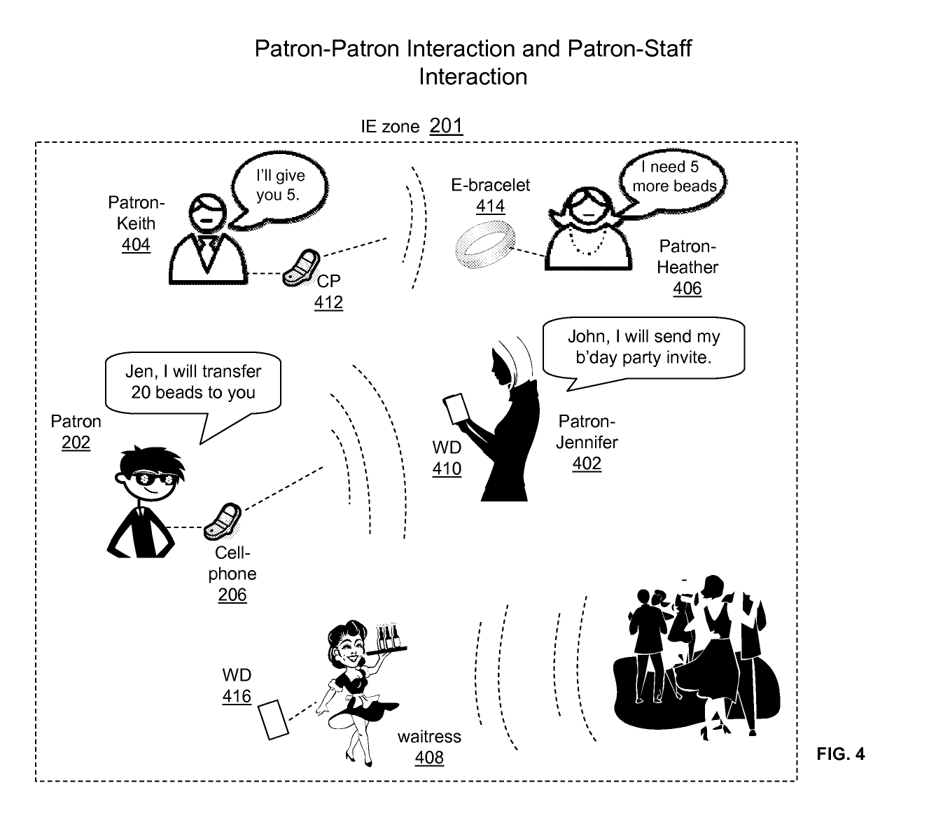

FIG. 4 illustrates patron and staff interactions within the electronically configured commercial/entertainment environment, according to one embodiment. In interaction zone 201, ISE utility 110 logs/records member and establishment activities including transactions and interactions of patrons/members and associates/employees of IE zone/establishment 201. Illustrated within interaction zone 201 is patron 202 who uses cell phone 206 to communicate online (e.g., transfer points or items within the account) with patron-Jennifer 402 who uses wireless device (WD) 410. Patron-Keith 404 initiates an electronic bead transfer and a “friend request”/“friend add” event with Patron-Heather 406. In addition, waitress 408 who utilizes wireless device 416 is also illustrated within interaction zone 201.

In interaction zone 201, patron-Heather 406 “breaks the ice” (i.e., initiates a conversation/social encounter) with patron-Keith 404 by announcing within ear shot of patron-Keith 404 that she, patron-Heather 406 wants 5 more (electronic) beads (also referred to herein as e-beads). Patron-Keith 404 accepts the request and offers to give patron-Heather 406 the five (5) e-beads that patron-Heather 406 requests. Patron-Keith 404 is equipped with cell phone 412 and patron-Heather 406 uses e-bracelet 414. ISE utility 110 enables patron-Keith 404 to initiate an item transfer and, in particular, a transfer of e-beads via application 232 which allows patron-Keith 404 to track his activities within IE zone 201 using the member account of patron-Keith 404. For example, ISE utility 110 enables Keith 404 to (a) select the item, (b) choose the quantity of items and (c) identify the member to whom the items are being transferred (i.e., a transferee). In one embodiment, ISE utility 110 enables automatic identification of the transferee by an ID signal transmitted by e-bracelet 414. Keith 404, who is initiating the bead transfer, automatically identifies the transferee via a detected ID signal. In one embodiment, ISE utility 110 enables Keith 404 to detect the signal from Heather 406 when Keith 404 also provides particular identification information of Heather 406 by using an application on cell phone 412. In another embodiment, Keith 404 may transfer items to the account of Heather 406 without requiring a signal from any device that Heather 406 uses but by searching for and finding an online account of Heather 406 before completing the transfer via exchange/transfer functions within establishment website 128. Keith 404 uses cell phone 412 to access establishment website 128 via an application which is similar to application 114/232.

In interaction zone 201, ISE utility 110 enables patron 202 to initiate a two-way transfer communication with patron-Jennifer 402. Patron 202 has previously configured his account to transfer items only to friends, via application 232. Thus, when patron 202 wishes to transfer beads/points to Jennifer 402, ISE utility 110 automatically sends a friend request via application 232 to Jennifer 402 who is not a current online friend. Jennifer 402 accepts the friendship request via a similar application on WD 410. ISE utility 110 notifies patron 202 of the new friendship via an application 232. ISE utility 110 allows patron 202 to complete the online beads/points transfer from the account of patron 202 to the account of his new friend, Jennifer 402. Jennifer 402 sends a real-time message of gratitude or one of a group of pre-programmed responses to patron 202 via the online application. In addition, Jennifer 402 sends patron 202 an invite/invitation to her upcoming 23^{rd} birthday party.

In interaction zone 201, waitress 408 fills the order of patron 202 which patron 202 initiates on cell phone 206 while dancing in the VIP dance space. Patron 202 selectively reports current activities in IE zone 201 to DPS 225 in order for waitress 408 and other friends to be able to find (and/or serve drinks) to Patron 202. For example, patron 202 may automatically report a location of patron 202 by one or more of: (a) in-club registration of activities, for example, electronically/wirelessly (ID) detected entrance to the VIP; LPS/GPS technology; location detection via processing of cell-phone/wireless communication signal. Patron 202 wants to be able to use different tracking timestamps to separate his order request from the receipt of the ordered items/products. Thus, patron 202 sets up this order for payment upon receipt of items. As a result, waitress 406 arrives with the ordered items and uses wireless device 416 which enables waitress 408 to initiate receipt of payment from patron 202 upon receiving a signature of patron 202 to authorize payment from the account of patron 202. ISE utility 110 notifies waitress 406 and patron 202 of the status of the transaction. Waitress 408 returns a copy of the signed receipt to patron 202 if the payment transfer is successful. When patron 202 subsequently reviews activities via the member account of patron 202, patron 202 sees “at timestamp1, patron orders X items” and “at timestamp2, patron 202 receives ordered items”. ISE utility 110 may allow a patron to configure the account to reflect/log all/select activities globally within the website based network community and/or locally, within the sub-community which represents IE zone 201. Patron 202 is also reminded via an online application that patron 202 has made seven new friends during the recent celebration in IE zone 201.

ISE utility 110 enables patron 202 to subsequently execute a login procedure and search for friendships initiated in IE zone 201. ISE utility 110 may allow members to search for other members based on previous attendance dates, joint attendance and expected joint attendance. Thus, a member may search for other members who have previous attendances at IE zone 201 in common with the searching member. ISE utility 110 may allow members to set expected dates of attendance, for example, via RSVP, and to search for members who are planning to attend IE zone 201 at the same time as the member who is conducting the search. Thus, ISE utility 110 allows members to meet before a live event and/or to re-connect following an event. ISE utility 110 may provide members with a unique feature, e.g., a “where have we met first/before?” feature, to search/recall experiences/encounters with another member.

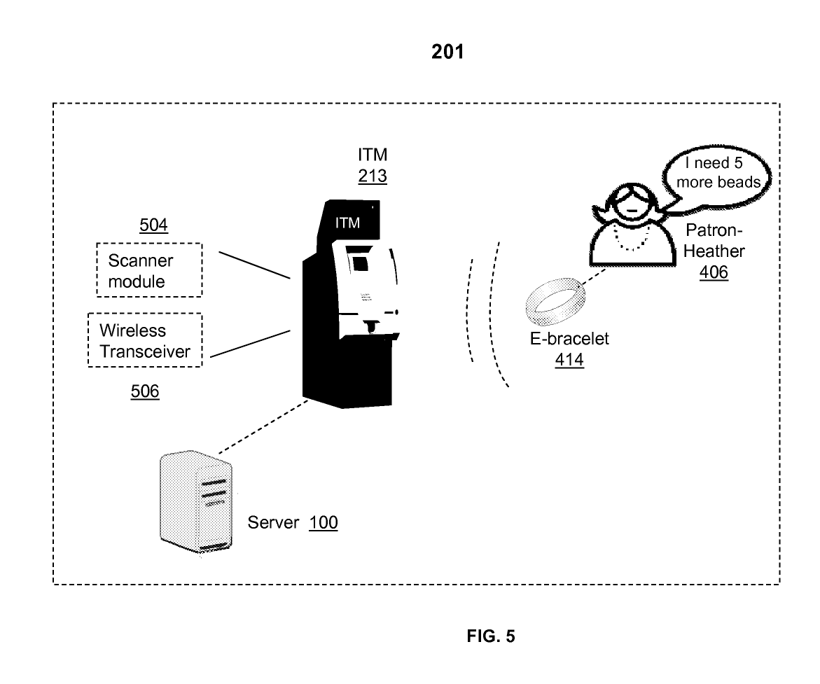

FIG. 5 illustrates a patron using an interactive transaction machine (ITM) within the electronically configured commercial/entertainment environment, according to one embodiment. Transaction environment (TE) 500 comprises ITM 213 which is connected to server 100. In addition, Heather 406 is located within TE zone 500. Heather 406 is able to perform a limited set of functions via the electronic bracelet. However, Heather 406 wishes to review points/beads/funds balance of her account. Heather 406 also wishes to add more funds to her account using a credit card. In one embodiment, ITM 213 is equipped with scanner module 504. In one embodiment, ATM 213 utilizes (a) a barcode which is read from e-bracelet 414 or from a non-electronic wristband via scanner module 504 and (b) a password to begin transactions.

ISE utility 110 enables patrons to connect to corresponding member accounts to perform transactions which include one or more of: (a) the viewing of point/credit balances; (b) the transfer of points; (c) addition of points/credit; and (d) purchase of electronic items, e.g., e-beads. Thus, an example event with interactive participation is a theme party such as Mardi Gras which utilizes a “bead system”. These electronic beads are the electronic version of the Mardi Gras beads. ISE utility 110 enables a manager/owner to initiate the creation of a small unique data file which represents an e-bead via an business/establishment operator's module of a website based application (e.g., application 114). ISE utility 110 provides patrons with transferable “beads” which patrons may transfer to other patrons/members. A patron may automatically transfer e-beads/points to another patron by detecting an ID signal of the transferee and then triggering application based functions to perform transfer of e-beads from a sender's account to a receiver's/transferee's online account. These e-beads are an example of entertainment items that may be used to create exciting games/activities within IE zone 201.

In one embodiment, ISE utility 110 enables a patron to add credit by using a debit/credit card. Thus, ITM 213 may be equipped with an electronic card reader to process credit/debit card data. In another embodiment, ITM 213 may be capable of accepting a cash deposit.

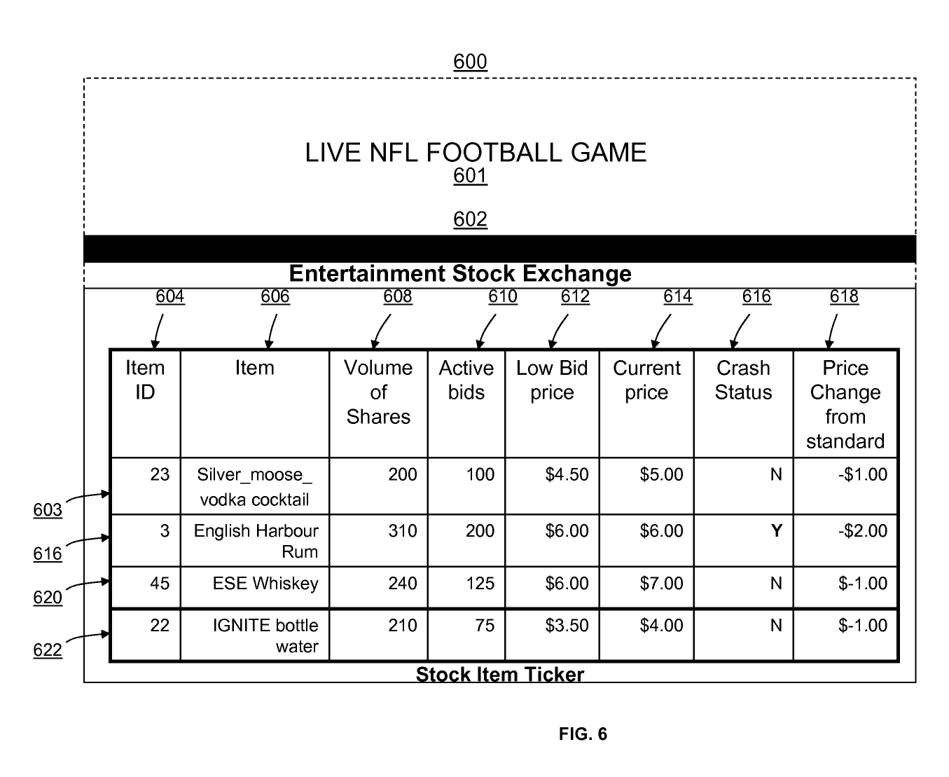

FIG. 6 illustrates an example television/display monitor showing a real time item price ticker, according to one embodiment. Monitor 600 comprises first monitor section/tv section 601 and second monitor section/ticker 602. Ticker 602 displays identification data and dynamic data for four items within four table rows. The data for each item is divided among six columns within ticker 602. In particular, ticker 602 comprises first row item 602, second row item 616, third row item 620 and fourth row item 622. Ticker 602 also comprises “item ID” column 604, name of “item” column 606, “volume of shares” column 608, “active bids” column 610, “low bid price” column 612, “current price” column 614, “crash status” column 616 and “price change from previous” column 618.

According to first row item 602, 200 “shares”/units/glasses of the silver moose vodka cocktail is sold. The current price of the silver moose vodka cocktail is $5.00 as indicated by “current price” column 614 of first row item 602. The current price of $5.00 is $1.00 less than the standard price, as indicated by “price change from standard/previous” column 618 of first row item 602.

ISE utility 110 provides a ticker display concurrent with a utilization of a monitor for the purpose of one or more of: (a) television viewing; (b) cable television viewing; (c) satellite television viewing; (d) website viewing; (e) mobile device viewing; (f) table monitor viewing; (g) localized ticker display viewing; (d) viewing of programs via electronic media; and other types of viewing that may be supported for the particular application of ISE utility. In one embodiment, ISE utility 110 allows a television/cable/video input signal to occupy a first section of the display screen only. ISE utility 110 allocates a second section for the display of ticker 602. During an item crash, ISE utility 110 may increase the display section allocated to ticker 602 and proportionately decrease the second section allocated to the television/cable/video input signal. ISE utility 110 may display item prices for a larger number of items during the item crash. ISE utility 110 may modify the look of the display/ticker by changing particular display parameters such as the color of the text and background, according to a particular theme. In one embodiment, only the specific item that has experienced a crash is displayed on the display screen along with the other content. This embodiment minimizes the mount of space allocated to tracking the status of bids on a large number of items.

ISE utility 110 may store multiple preprogrammed themes, “events”, “parties” or “specialty” nights, e.g., Mardi Gras Party, NFL Draft, NCAA March Madness picks, St. Patrick's Day, “Spring Break”, etc. Each particular event may highlight specific theme related beverages and/or food. ISE utility 110 enables a manager/owner to store/add personal themes at the manager's discretion. Thus, ISE utility 110 enables a manager to pre-configure implementations of one or more special events based on one or more of: (a) specific theme related items corresponding to the particular special event; (b) a specific theme related audio-visual display; and (c) specific functions that are utilized. ISE utility 110 stores implementation data for said implementations of one or more special events. Thus, ISE utility 110 pre-programs/pre-configures one or more special events. ISE utility 110 initiates a pre-configured special event by using the stored implementation data corresponding to the particular pre-configured special event. These special events may include one or more of: (a) item transaction sales event; (b) a Mardi Gras Party; (c) a NFL Draft party; (d) an NCAA March Madness party; (e) a St. Patrick's Day party; (f) a Spring Break event; and (g) other special events.

ISE utility 110 displays the change in price via “price change from standard/previous” column 618 as being more or less expensive from the previous/standard price. ISE utility 110 allows a member/patron to utilize a Bid/Ask system to set up individual and/or bulk orders. Thus, ISE utility 110 allows customers to request a large order and ask for a reduced price (i.e., the bid). ISE utility 110 enables a manager to set a price criterion for accepting these Bid/Ask bulk orders. The “Ask” price is the price the manager is willing to accept. In ticker 602, the largest number of bids has been placed for English Harbor Rum, as indicated within “active bids” column 610. However, the smallest number of bids has been placed for fourth row item 622 which is represented by “IGNITE” bottle water. ISE utility 110 triggers an item (price) crash event based on one or more of: (a) a preset schedule; (b) random interval selection; (c) volume of sales of an item; and (d) a spontaneous manual trigger (e.g., manager's discretion). As shown by current price column 614, the price of English Harbour Rum has crashed to the corresponding bid price in low bid price column 614, as indicated by the notification (“Y”) in crash status column 616. In actual implementation, the notification may be a change in the size or font of that row of the ESE table.

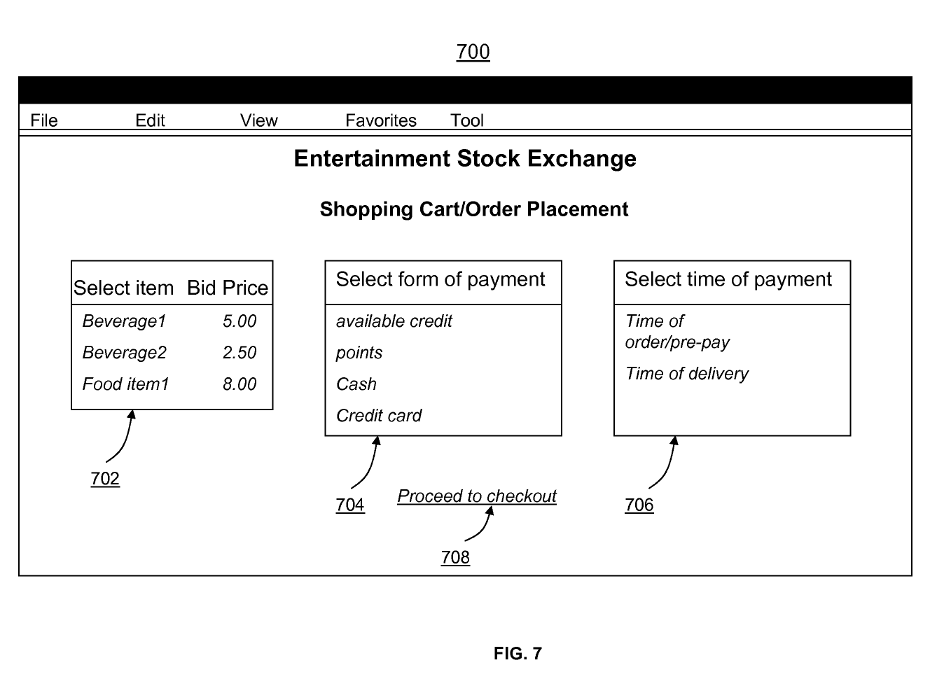

FIG. 7 illustrates an example display of a web-based order page, according to one embodiment. Order page 700 comprises multiple interactive (input) forms (e.g., an HTML form) of which item selection dropbox 702 (which includes corresponding bid price selection entries), payment selection dropbox 704 and time of payment dropbox 706 are illustrated. In addition, proceed to checkout link 708 is illustrated to facilitate the completion of the order request.

ISE utility 110 enables patron 202 to use cell phone 206 to purchase food/drinks Patron 202 makes an online order via order page 700 by using cell phone 206. ISE utility 110 executing on device-A 225 detects receipt of the online order. ISE utility 110 designates the order as a pending order. Patron 202 chooses to pay for the order at the time of order request (i.e. patron 202 pre-pays) by selecting the appropriate option within time of payment dropbox 706. ISE utility 110 also receives indication that patron 202 wants the costs to be deducted from the member purchasing account of patron 202. ISE utility 110 verifies an availability of sufficient credit/points/funds in the member purchasing account before filling the order. The order is filled when transactions pertaining to the order are completed. As a result, ISE utility 110 designates the order as a filled order and schedules the order for delivery based on one or more of: (a) a requested time by the patron; (b) immediately, e.g., for VIP orders; (c) a maximum waiting period; and (d) a tip incentive for a waitress servicing a series of orders.

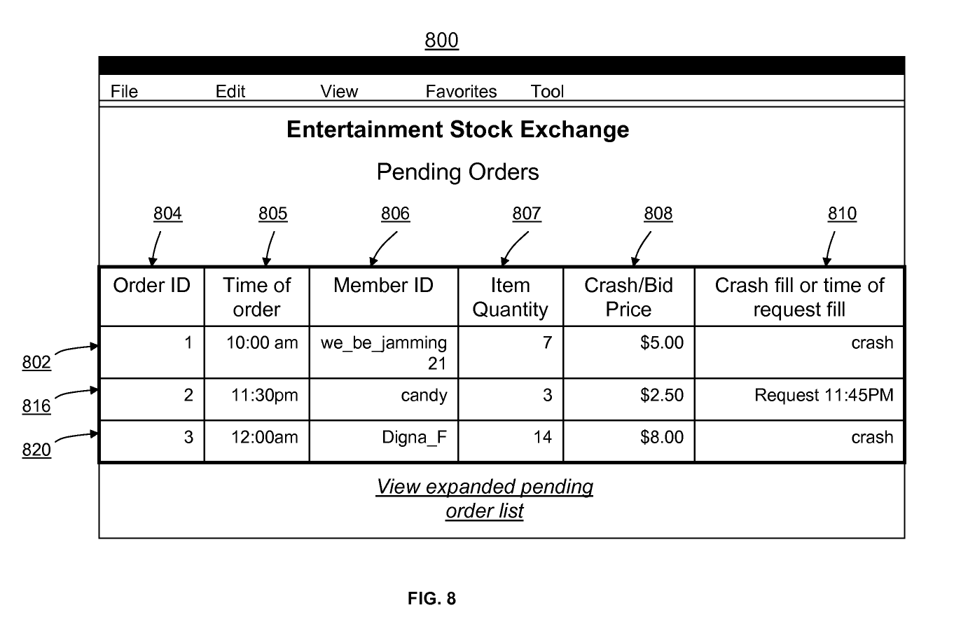

FIG. 8 illustrates an example display of a web-based pending orders page, according to one embodiment. Order page 800 displays information pertaining to specific orders within a list of pending orders. The data for each order item is divided among four columns within order page 800. In particular, order page 800 comprises first row item 802, second row item 816 and third row item 820. Order page 800 also comprises “order ID” column 804, “Time of Order” column 805, name/“Member ID” column 806, “Item Quantity” column 807, “bid/crash price” column 807, and “crash fill or time of request fill” column 810.

According to first row item 802, at 10:00 am, member “we_be_jamming21” pre-ordered seven items to be filled at crash prices only. Second row item 816 indicates that member “Candy” ordered three items to be filled/purchased at the prices at time of the request. The patron (e.g., member “Candy”) may submit a bid and also indicate the preferred time for the item to be delivered to the patron's table (e.g., 11:45 PM). The patron may go to the dance floor, enjoy a few dances and then return to the table at the pre-set/preferred time that the patron knows the waitress is delivering the ordered item. ISE utility 110 may also provide a reminder notification (to the patron's mobile electronic device/bracelet, for example) of the approaching time for item delivery.

ISE utility 110 may enable priority delivery of an ordered item(s) based on the tipping incentive added to the bid order. Thus, the patron is also given an opportunity to provide a generous bid on service tips. ISE utility 110 determines a range of tips which may be itemized according to preset percentages of the costs of the ordered items. ISE utility 110 allows the patron to select a tip when submitting a bid order. ISE utility 110 may also allow the patron to select a different tip value via a text box. In one embodiment, ISE utility 110 may utilize the size of the tip to determine the position at which the patron's order is placed in the waitress order delivery queue. Therefore, if the patron is a big tipper, the patron may be afforded the treatment of an A-list patron whose treatment includes obtaining quicker service.

ISE utility 110 may provide bid approval notification to a patron to enable the patron to pick up ordered items. During a crash/special event a large number of crash orders and bid orders are filled. Given a large number of bids/crash orders associated with the crash, a large number of patrons may expect service at the bar at a particular time. ISE utility 110 determines the number of orders/items the bar staff is expected to service at the impending crash. To reduce chaos and improve service efficiency, ISE utility 110 may send an earlier notification of an impending crash to the bar tender and other service staff via the bar tender's computer/station. For example, the notification may indicate that X number of item A are required in 10 minutes, in order to give the bar tender and/or service staff some lead time to be able to take appropriate action. In addition, ID/bar code scanners may be provided at specific locations at the bar so that patrons whose bids for item X are accepted may go to the bar, have an e-bracelet or wrist-band scanned to allow these patrons to collect the discounted/bid item. As an alternative, patrons may be identified by an ID signal (that is transmitted by cell phones or e-bracelets using RFID or Bluetooth technology) via an ID signal scanner before receiving the discounted item(s). ISE utility 110 may provide visual identification of person to a bar tender via a bar/order monitor as a patron who submitted an order which is approved for order pickup. Thus, ISE utility 110 allows the bartender to efficiently fill each patron's order.

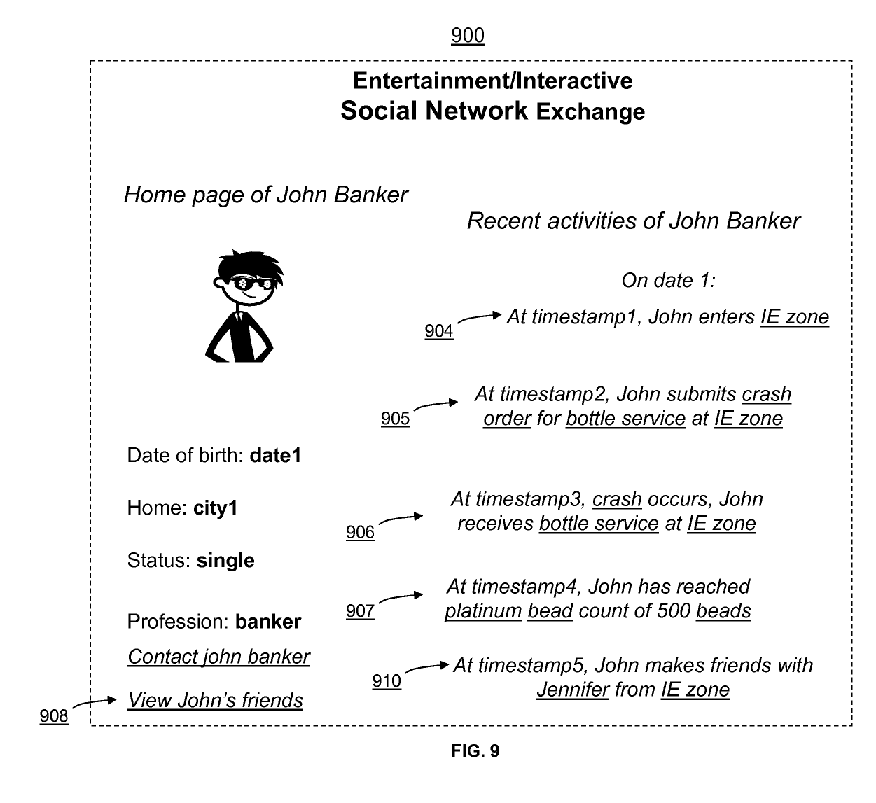

FIG. 9 illustrates an example display of a member homepage on a social network website, which supports Entertainment/Interactive Social Network Exchange, according to one embodiment. Member homepage 900 comprises first activity log/track 904, second activity log/track 905, third activity log/track 906, fourth activity log/track 907 and fifth activity log/track 910.

When ISE utility 110 determines that a particular event is initiated (or occurs) within the configured space of IE zone 201, ISE utility 110 automatically triggers creation (or creating) of a record of the event within a specified page of an online application for a particular member or group of members involved in the event. ISE utility 110 may also provide a link to pages of the other participants (e.g., by placing a hypertext link on a member's page to provide access to the pages of the other members/participants). ISE utility 110 may create the record as one or more of: (a) a real-time instantaneous log; (b) a delayed log/record with limited record editing capability. ISE utility 110 may create records on a member's page of various types of events.

ISE utility 110 enables patron 202 to execute a login procedure to access the member account of patron 202 and review activities. When patron 202 reviews activities via the member account, ISE utility 110 may allow patron 202 and visitors to member homepage 900 to see “at timestamp1, patron enters IE zone” and “at timestamp2, patron 202 submits a “crash” order for bottle service, according to first activity log/track 904 and second activity log/track 905. When a “crash” occurs, patron 202 receives ordered items”, according to third activity log/track 906. Patron has reached the platinum milestone for bead count, according to fourth activity log/track 907. Patron 202 is also reminded via application 232 that patron 202 has made several new friends during the recent celebration in IE zone 201. Fifth activity log/track 910 indicates a new friendship with Jennifer 402.

ISE utility 110 utilizes a number of hypertext links to represent certain key words within member homepage 900. For example, according to third activity log/track 906, hypertext links are used to represent the following words/phrases: (a) crash; (b) bottle service; and (c) IE zone. When these hypertext links are accessed, ISE utility 110 enables a website visitor to view the appropriate pages on the establishment website of IE zone 201 and/or the appropriate pages of the site of an in-club promoter/producer/sponsor. In addition, ISE utility 110 enables John's friends to be displayed via link 908.

ISE utility 110 may allow patron 202 to search within a particular time period for friendships initiated in IE zone 201. ISE utility 110 may allow members to search for other members based on previous attendance dates, joint attendance (i.e., when the member being searched has a common attendance in IE zone 201 as the member who is conducting the search) and expected joint attendance. Thus, a member may search for other members who have previous attendances at IE zone 201 in common with the searching member. ISE utility 110 may allow members to set expected dates of attendance, for example, via RSVP, and to search for other members providing RSVP notifications to indicate a future attendance at IE zone 201. Thus, ISE utility 110 allows members to meet before a live event and/or to re-connect following an event. ISE utility 110 may provide members with a unique feature, e.g., a “where have we met first/before?” feature via social networking website 140, to search/recall experiences/encounters with another member.

ISE utility 110 provides members/patrons/users with the ability to track respective activities via a website based application (e.g., application 232). A user is able to track social activities, business interactions, as well as other electronically facilitated activities/events. Thus, ISE utility 110 effectively enables a member/user/patron to instantly track/record and provide a broadcast/log of many aspects of the member's life. In a specific example application, ISE utility 110 may enable a member to produce an online “reality” type show based on instant and automated activity logging/broadcasting/monitoring via website based interactive multimedia applications.

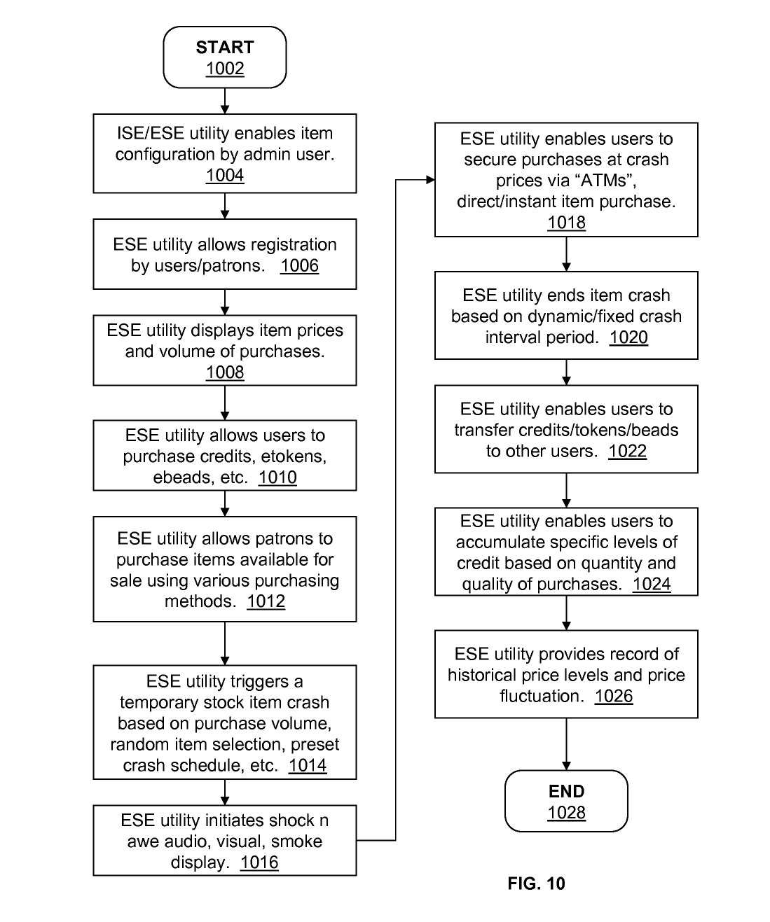

FIG. 10 is a flow chart illustrating the method by which the above process of the illustrative embodiments is completed. In particular, FIG. 10 illustrates the process of providing interactions between registered members, enabling transactions involving members and electronically activating special events in the electronically configured commercial/entertainment establishment. Although the method illustrated in FIG. 10 may be described with reference to components shown in FIGS. 1-9, it should be understood that this is merely for convenience and alternative components and/or configurations thereof can be employed when implementing the various methods. Key portions of the methods may be completed by ISE utility 110 executing on processor 101 within DPS 100 (FIG. 1) and controlling specific operations of/on DPS 100, and the methods are thus described from the perspective of either/both ISE/ESE utility 110 and DPS 100. For purposes of the flow charts, references to ISE utility are utilized, but may also be considered references to ESE utility.

The process of FIG. 10 begins at initiator block 1002 and proceeds to block 1004, at which Interactive Stock Exchange (ISE) utility 110 provides an administrative user/owner 230 with a graphical user interface for entertainment application 114 on DPS 100 to configure items, prices and stock point values. In one embodiment, ISE utility 110 provides automatic conversion of prices of pre-existing items on a stock list to corresponding stock point values. At block 1006, ISE utility 110 allows registration by users/patrons. At registration, ISE utility 110 provides patrons/users with one or more of: (a) entry access to IE zone 201; (b) initialization of transacting accounts linked to a corresponding web-based member account; and (c) communication access with the use of a wireless device within IE zone 201.

At block 1008, ISE utility 110 initiates the display of item prices and volume of purchases. ISE utility 110 allows users to purchase credits and promotional/activity items including, for example, electronic tokens and electronic beads, as shown at block 1010. At block 1012, ISE utility 110 allows patrons to purchase items available for sale based on available credit in an account accessed via a website based application. In particular, ISE utility 110 enables patrons to order/purchase items by one or more of: (a) an online bid order; (b) a crash or special event order; (c) a pre-event order; and (d) an employee assisted order. At block 1014, ISE utility 110 triggers a temporary stock item crash based on purchase volume, random item selection, preset crash schedule, etc. At block 1016, ISE utility 110 initiates “shock and awe”/vivid audio/visual/smoke display. At block 1018, ISE utility 110 enables users to secure purchases at crash prices via “ATMs”, direct/instant item purchase. At block 1020, ISE utility 110 ends the item price crash based on dynamic/fixed crash interval period.

At block 1022, ISE utility 110 enables users to transfer credits/tokens/beads to other users. A patron may establish personal guest lists to enable friends with pre-paid access to establishment via one or more procedures (e.g., electronically/manually mapping user ID1 to user ID2) and bar tabs, etc. A tab may be established based on available credits or by using cash or credit/debit card. ISE utility 110 may enable a patron to receive notification/indication when placed on another patron's guest list prior to initiating entry to IE zone 201.

At block 1024, ISE utility 110 enables users to accumulate specific levels of credit based on quantity and quality of purchases. By linking activities/transactions to a member ID/account, ISE utility 110 may provide point rewards for levels of purchases. At block 1026, ISE utility 110 records/stores historical price levels and price fluctuation. The process ends at block 1028.

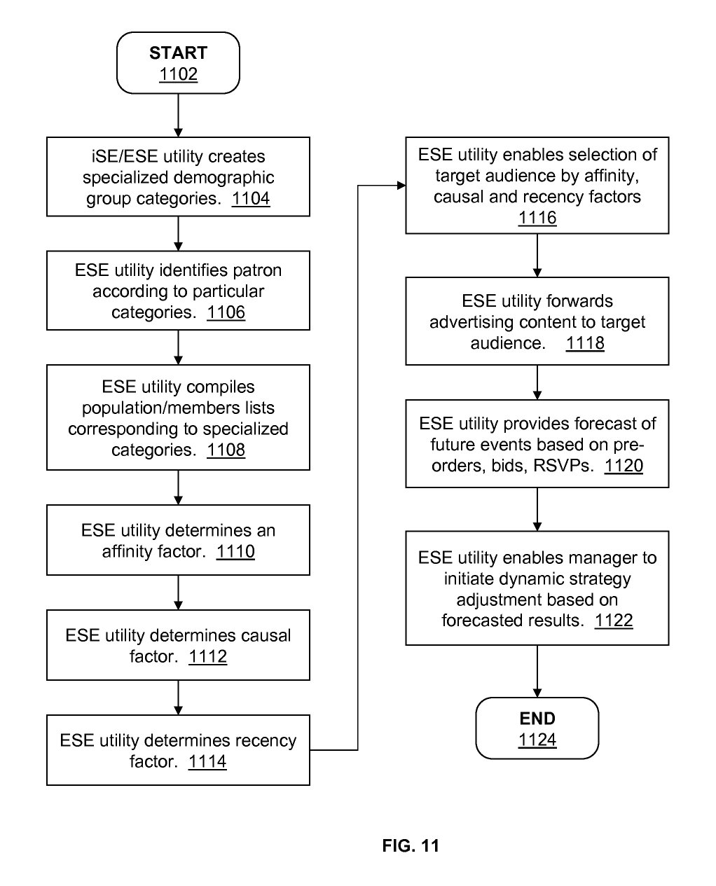

FIG. 11 is a flow chart illustrating the process of creating specialized categories of demographic groups, populating lists based on the specialized categories, sending advertising content to particular members of these specialized categories, and forecasting the performance/success of future events, according to one embodiment. The process of FIG. 11 begins at initiator block 1102 and proceeds to block 1104, at which Interactive Stock Exchange (ISE) utility 110 creates a number of specialized demographic group categories based on one or more of: (a) information about actions reported; (b) a preset group of categories associated with a range of actions reported by a particular business/establishment; and (c) pre-arranged set of categories pertaining to a particular type of business/establishment and business activities associated with information in respective reports. At block 1106, ISE utility 110 identifies patrons according to particular categories based on reported/recorded activities. At block 1108, ISE utility 110 compiles population/members lists corresponding to specialized categories based on patrons involved in reported activities. ISE utility 110 determines an affinity factor to describe a level of association a member has with a particular item/service/event/place, based on the patron's reported activities, as shown at block 1110. At block 1112, ISE utility 110 determines causal factor to describe a level of association of multiple of activities.

At block 1114, ISE utility 110 determines a recency factor for a level of recent activity that associates a member/patron with the particular item or service. In particular, the recency factor provides a measure of the level of a particular activity within a specified time period. ISE utility 110 dynamically updates the recency factor when a new instance of a reported activity and/or less recent activities which are previously used to determine the recency factor are removed as components in the determination of the current measure of the recency factor. In one embodiment, ISE utility 110 calculates the recency factor based on a simple moving average or a weighted moving average.

At block 1116, ISE utility 110 enables selection of target audience by one or more of: (a) an affinity factor; (b) a causal factor; and (c) a recency factor. At block 1118, ISE utility 110 forwards advertising content to the selected target audience. At block 1120, ISE utility 110 provides forecast of future events based on the forecast indicators which include one or more of: (a) RSVP notifications; (b) pre-orders including bids; (c) a level/volume of item trading; (d) observed trends; and (e) other forms of pre-event notifications. At block 1122, ISE utility 110 enables a manager to initiate dynamic strategy adjustment based on forecasted results. In particular, a manager is able to adjust a planning strategy to ensure the success of a future event based on indications the forecast provide. The process ends at block 1124.

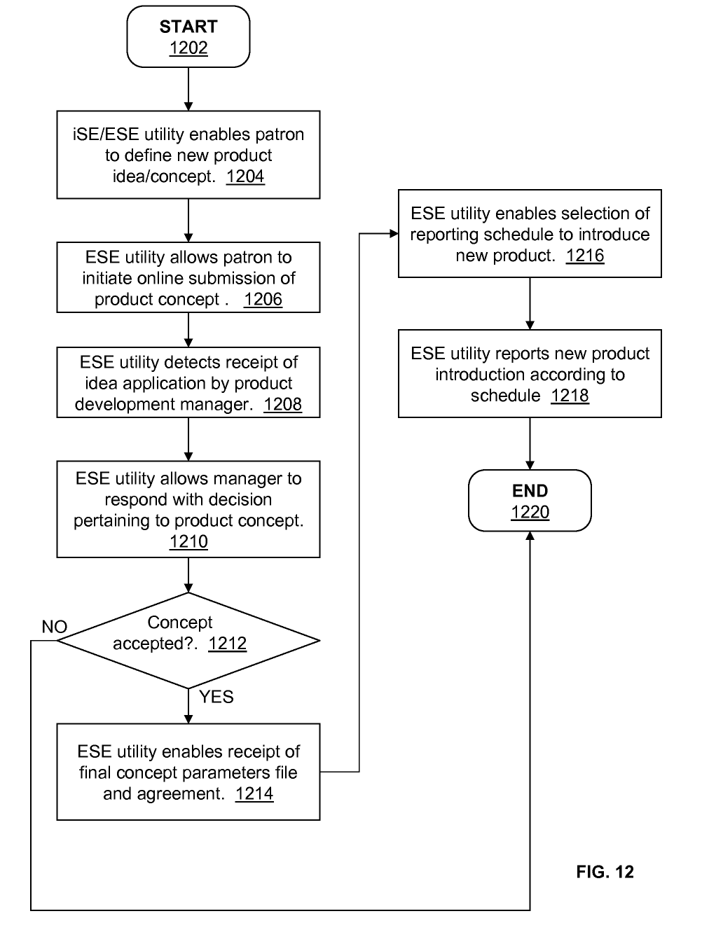

FIG. 12 is a flow chart illustrating the process of developing a new product/service concept, obtaining approval for implementation for the product/service and advertising the introduction of the new product/service concept online, according to one embodiment. The process of FIG. 12 begins at initiator block 1202 and proceeds to block 1204, at which Interactive Stock Exchange (ISE) utility 110 provides patron 202 with a graphical user interface (GUI) via application 232 to enable patron 202 to define new product idea/concept. At block 1206, ISE utility 110 allows patron 202 to initiate online submission of the product concept. At block 1208, ISE utility 110 detects receipt of the product concept application by a product development manager. ISE utility 110 allows manager to respond online with a decision pertaining to acceptance of the product concept, as shown at block 1210.

At decision block 1212, ISE utility 110 determines whether the product concept is accepted. If at block 1212 ISE utility 110 determines that the product concept is accepted, ISE utility 110 enables receipt of a final concept specification/parameters file and agreement by patron 202, as shown at block 1214. At block 1216, ISE utility 110 enables selection of a report schedule in order to introduce the new product. At block 1218, ISE utility 110 reports the new product's introduction according to a reporting schedule. However, if at block 1212 ISE utility 110 determines that the product concept is not accepted, the process proceeds to block 1220, at which block, the process ends.

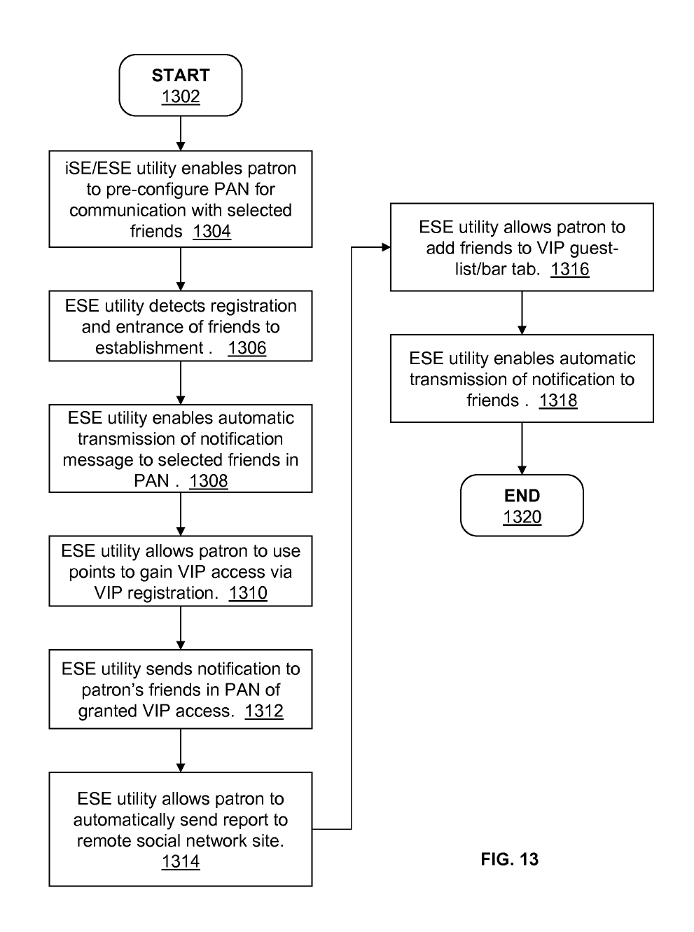

FIG. 13 is a flow chart illustrating the process of configuring a personal area network (PAN), automatically notifying members connected to the PAN of selected member activities and reporting of particular activities to a community networking website, according to one embodiment. The process of FIG. 13 begins at initiator block 1302 and proceeds to block 1304, at which Interactive Stock Exchange (ISE) utility 110 enables patron 202 to pre-configure a PAN for communication with selected friends within an electronically configured space. At block 1306, ISE utility 110 detects the registration and entrance of friends to establishment.

At block 1308, ISE utility 110 enables two-way automatic transmission of notification message to selected friends and patron 202 in PAN. In particular, patron 202 is notified of the friends' registration. The friends of patron 202 are informed that patron 202 has already entered IE zone 201. ISE utility 110 allows patron 202 to use points to gain VIP access via VIP registration, as shown at block 1310. At block 1312, ISE utility 110 sends notification to patron's friends in PAN of granted VIP access. At block 1314, ISE utility 110 allows patron to automatically send report about VIP access to remote/online community networking site. At block 1316, ISE utility 110 allows patron 202 to add the friends to the VIP guest-list/bar tab of patron 202. At block 1318, ISE utility 110 enables automatic transmission of notification to the friends of patron 202 which friends are connected to the PAN. The process ends at block 1320.

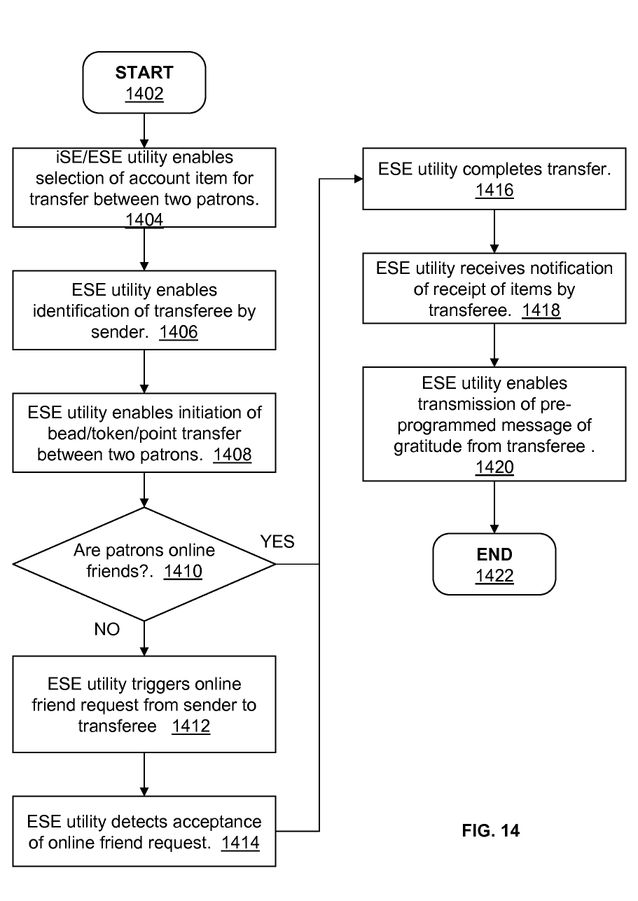

FIG. 14 is a flow chart illustrating the process of externally triggering an event in a community networking site based on an event executed within an electronically configured establishment, according to one embodiment. The process of FIG. 14 begins at initiator block 1402 and proceeds to block 1404, at which Interactive Stock Exchange (ISE) utility 110 enables selection of an account item by a first patron (e.g., patron 202) in order to transfer the account item to a second patron. At block 1406, ISE utility 110 enables identification of the transferee/second patron by the sender/patron 202. At block 1408, ISE utility 110 enables initiation of bead/token/point transfer between the sender and the transferee. At block decision block 1410, ISE utility 110 determines whether the two patrons are online friends (i.e., friends on a particular community networking site). If at block 1410 ISE utility 110 determines that the two patrons are not online friends, ISE utility 110 triggers an online friend request from sender to transferee, as shown at block 1412. At block 1414, ISE utility 110 detects the acceptance of the online friend request by the transferee. However, if at block 1410 ISE utility 110 determines that the two patrons are already online friends, ISE utility 110 completes the item transfer, as shown at block 1416. At block 1418, ISE utility 110 receives notification of the receipt of the items by the transferee. At block 1420, ISE utility 110 enables the transmission of a pre-programmed message of gratitude from the transferee. The process ends at block 1422.

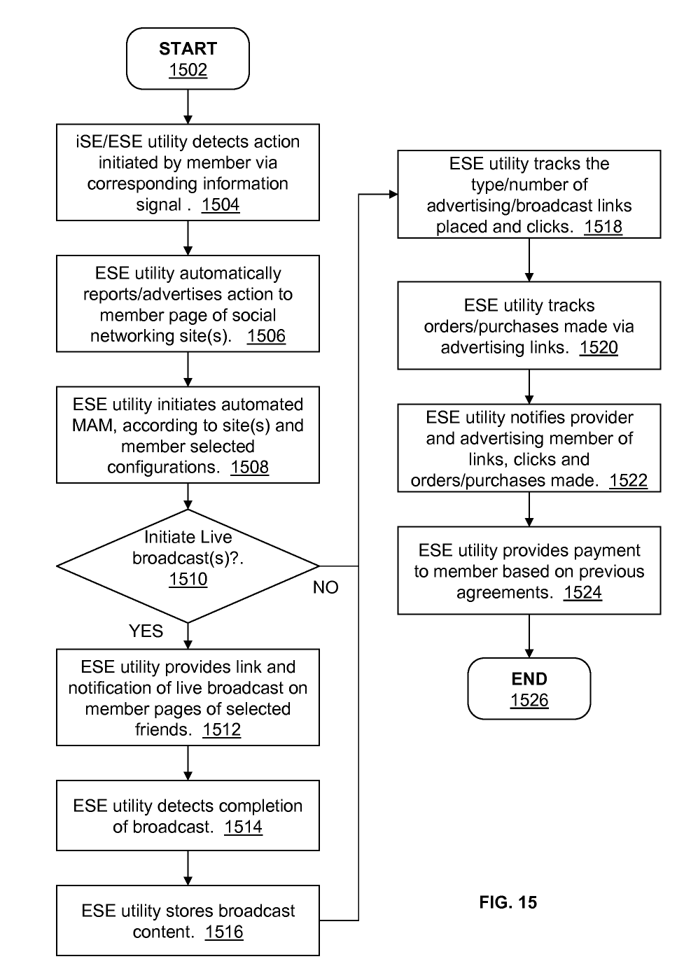

FIG. 15 is a flow chart illustrating the process of reporting and advertising information/content related to member activities in an electronically configured establishment to/within a community networking site, according to one embodiment. The process of FIG. 15 begins at initiator block 1502 and proceeds to block 1504, at which Interactive Stock Exchange (ISE) utility 110 detects an action being initiated by patron 202 via a corresponding information signal. At block 1506, ISE utility 110 automatically reports/advertises the detected action to the corresponding member page of patron 202 within one or more social networking site(s). At block 1508, ISE utility 110 initiates the automated multiplier advertising mechanism (MAM), according to site(s) and member's pre-selected configuration settings. In particular, ISE utility 110 reports/advertises the detected action on the online pages of the online friends of patron 202. In addition, ISE utility 110 reports/advertises the detected action on the online pages of other members, according to a pre-configured degree of separation of online friendship for reported content. At decision block 1510, ISE utility 110 determines whether a (live) broadcast of ongoing actions of/featuring patron 202 within IE zone 201 is to be initiated on the online social/community networking website. If at decision block 1510 ISE utility 110 determines that a (live) broadcast is to be initiated on the online social/community networking website, ISE utility 110 provides the (hypertext/website) link and a notification of the live broadcast on the online member pages of selected friends, as shown at block 1512. In one embodiment, ISE utility 110 shows the live broadcast in member's pages if the broadcast is occurring live (i.e., substantially concurrent with the action in the electronically configured space). At block 1514, ISE utility 110 detects the completion of the live broadcast. At block 1516, ISE utility 110 records/stores the broadcast content.

However, if at decision block 1510 ISE utility 110 determines that a (live) broadcast is not going to be initiated on the online social/community networking website, ISE utility 110 tracks the type/number of advertising/broadcast links placed and the source/number of clicks on these links, as shown at block 1518. At block 1520, ISE utility 110 tracks the orders/purchases made via the advertising links. At block 1522, ISE utility 110 notifies provider and advertising member of links, clicks and orders/purchases made via these links. At block 1524, ISE utility 110 provides payment to the notified member based on previous sales agreements. In one embodiment, ISE utility 110 automatically provides members with compensation based on activities including transactions executed via website links. For example, ISE utility 110 may provide members with compensation based on one or more of: (a) the amount of advertising content displayed; (b) the number of clicks via hypertext/website links corresponding to the advertising content; (c) the number of bids or orders placed via the hypertext/website links; (d) the quality of said bids (i.e., bid price relative to the ask/asking price) or orders placed via the hypertext/website links; (e) the number of filled order requests; (f) a net value/revenue of/from filled order requests. The process ends at block 1526.

The illustrated and described embodiments provide, in a data processing system, a method, a system and a computer program product that configures an electronic device to enable an individual to use the electronic device to initiate actions including one or more of: (a) item transactions; and (b) interactions with other individuals. The ISE logic/utility registers the individual for access to said electronically configured establishment with authorization to initiate one or more of: (a) item transactions; and (b) interactions with other individuals. The ISE utility triggers an initiation of a specific transaction and interaction (STI) event which includes a crash period. The ISE utility pre-selects temporary target prices which are applied to one or more products or services during the crash period. The ISE utility dynamically displays item information including item prices via an item ticker on one or more display monitors. The ISE utility modifies item prices from standard prices towards temporary target prices based on one or more of: (a) volume of sales of corresponding items; and (b) time conditions. The ISE utility dynamically selects items for which information about the items is displayed on a display monitor based on one or more of: (a) a volume of transactions corresponding to the items; (b) place of the items in a display waiting queue; (c) pre-existing agreement pertaining to the items; and (d) manager's discretion. The ISE utility allows patrons to initiate online order requests by a number of procedures which include one or more of: (a) a bid order; (b) a crash or STI event order; (c) a pre-event order; and (d) an employee assisted order. When the temporary target price is reached, the ISE utility initiates the crash period.

The ISE utility enables the individual to interact with other individuals to perform actions including transactions which are based on one or more of: (a) transfer of items; (b) transfer of financial credit; (c) transfer of items purchased; and (d) a trade of purchased items for other items or financial credit; (e) re-selling of acquired items. The ISE utility automatically reports information about actions initiated by the individual to one or more of: (a) a first application within the data processing device; (b) a second application on a remote server; and (c) a community networking website application. In addition, the ISE utility enables advertising content based on the information about actions reported by a particular establishment to be displayed on one or more of: (a) a community networking website; and (b) an establishment website controlled by the particular establishment. The ISE utility creates specialized categories of demographic groups based on a compilation of information reported by the particular establishment about a set of actions initiated by one or more individuals. The ISE utility identifies individuals as group members of said specialized categories of demographic groups based on the reported activities of the individuals. The ISE utility compiles population lists for the specialized categories of demographic groups according to the recorded activities of individuals. The ISE utility enables a selection of a target audience based on one or more of: (a) the affinity factor; (b) the causal factor; and (c) the recency factor. The ISE utility enables advertising content to be forwarded to the target audience. In addition, the ISE utility enables an event planner to obtain a forecast of a level of interest in a future event based on specific activities which are associated with the forecast indicators, which forecast indicators are obtained from one or more of: (a) RSVP notifications; (b) pre-orders including bids; (c) a level of item trading; (d) observed trends; (e) other forms of pre-event notifications.

The flowcharts and block diagrams in the various figures presented and described herein illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the flow charts above, one or more of the methods are embodied in a computer readable medium containing computer readable code such that a series of steps are performed when the computer readable code is executed (by a processing unit) on a computing device. In some implementations, certain processes of the methods are combined, performed simultaneously or in a different order, or perhaps omitted, without deviating from the spirit and scope of the invention. Thus, while the method processes are described and illustrated in a particular sequence, use of a specific sequence of processes is not meant to imply any limitations on the invention. Changes may be made with regards to the sequence of processes without departing from the spirit or scope of the present invention. Use of a particular sequence is therefore, not to be taken in a limiting sense, and the scope of the present invention extends to the appended claims and equivalents thereof.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, R.F, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. In a data processing system, a method comprising:
configuring an electronic device to enable an individual to use said electronic device to initiate actions including one or more of: (a) item transactions; (b) activities and interactions with other individuals; and (c) reporting of activities and transactions;
detecting an initiation of said actions initiated by said individual via said electronic device;
activating one or more functions provided by said data processing system in order to execute said actions initiated by said individual;
in response to an activation of said one or more functions provided by said data processing system, providing notification of execution of said action to said electronic device;
recording information about said actions; and
automatically reporting information about said actions initiated by said individual to one or more of: (a) a first application within said data processing device; (b) a second application on a remote server; and (c) a community networking website application.

2. The method of claim 1, wherein said reporting further comprises:
configuring said community networking website application to receive said information about said actions reported;
detecting receipt of said information reported to said community networking website application;
recording said information about actions initiated by said individual within said community networking website application;
displaying said information about actions initiated by said individual within said community networking website application as one or more of: (a) a record which is publicly displayed; and (b) a private record/log;
translating said information about actions initiated by said individual into advertising content;
displaying said advertising content within said community networking website application;
providing multiple instances of said advertising content displayed, according to a multiplier advertising mechanism; and
according to said information about actions initiated by said individual, automatically initiating a broadcast of actions and ongoing activities initiated by said individual.

3. The method of claim 1, further comprising:
enabling said action initiated by said individual to be reported to one or more of: (a) said data processing device; and (b) a server on a remote network;
pre-selecting one or more of: (a) automatic responses to particular actions; (b) notification messages corresponding to particular actions;
providing automatic responses by one or more of: (a) a response within a local network; (b) a response within a remote network;
when said individual initiate activities/transactions involving other individuals or other activities, providing one or more automatic responses, wherein said one or more automatic responses include an initiation of a request for online friendship from said individual to said other individuals;
wherein said one or more automatic responses include an activation of functions provided by said community networking website application;
recording information about said activation of functions provided by said community networking website application;
displaying information about said activation of functions provided by said community networking website application; and
reporting information about said activation of functions provided by said community networking website application to said data processing device.

4. The method of claim 1, wherein said reporting further comprises:
creating specialized categories of demographic groups based on a compilation of information reported by a particular establishment about a set of actions initiated by one or more individuals;
identifying said individual as a group member of one or more of said specialized categories of demographic groups based on reported actions of said individual;
compiling population lists for the specialized categories of demographic groups according to reported actions and activities of individuals;
determining an affinity factor for a level of association said individual has with a particular item or action;
dynamically updating the affinity factor when a new instance of a reported activity associating said individual with the particular item or action is identified;
according to reported information, determining in relation to said individual a causal factor for a level of association between one or more of: (a) multiple items; (b) multiple actions; and (c) multiple items and actions;
dynamically updating the causal factor when a relevant new instance of a reported activity by said individual is identified;
determining a recency factor for a level of recent activity that associates said individual with the particular item or action;
dynamically updating the recency factor based on one or more of: (a) a relevant new instance of a reported activity by said individual is identified; and (b) an expiration of previously reported activities, according to a criterion used to determine said recency factor;
selecting a target audience based on one or more of: (a) the affinity factor; (b) the causal factor; and (c) the recency factor;
forwarding advertising content to said target audience; and
obtaining a forecast of a level of interest in a future event based on specific activities which are associated with forecast indicators;
wherein said forecast indicators are obtained from one or more of: (a) RSVP notifications; (b) pre-orders including bids; (c) a level of item trading; (d) observed transaction trends; (e) other forms of pre-event notifications.

5. The method of claim 1, wherein said configuring further comprising:
enabling said individual to create and configure one or more personal area networks (PANs) within a local area network (LAN); and
enabling communication of messages between friends connected via said PAN; and
automatically providing notification messages about selected activities of said individual to friends of said individual connected to said PAN, according to preset configuration parameters.

6. The method of claim 1, further comprising:
enabling said individual to develop a definition of a new item for a particular establishment in order to provide: (a) transactions pertaining to said new item; and (b) interactions associated with said new item;
transmitting information about said definition of said new item to a product development representative for evaluation of said new item;
detecting receipt by said individual of a application decision notification from said product development representative;
receiving a copy of said application decision notification;
retrieving new item information from said copy of said application decision notification;
recording said new item information;
wherein said new item information provides indication of one or more of: (a) final item composition; (b) new item price; and (c) other implementation parameters;
pre-selecting a reporting schedule for transmission of said new item information to one or more of: (a) said first application within said data processing device; (b) said second application on a remote server; and (c) said community networking website application; and
according to said reporting schedule, when said new item information is recorded in said data processing system, transmitting a report containing said new item information to one or more of: (a) said first application within said data processing device; (b) said second application on a remote server; and (c) said community networking website application.

7. The method of claim 1, further comprising:
mapping advertising content displayed including display website links to said individual;
associating orders and transactions to hypertext links mapped to particular member; and
notifying said individual of activities including transactions completed via said website links; and
automatically providing said individual with compensation based on activities including transactions executed via said website links.

8. A data processor system comprising:
a memory;
one or more processors;
a wireless transceiver;
network connectivity;
a utility which when executed on said processor provides the functions of:
configuring an electronic device to enable an individual to use said electronic device to initiate actions including one or more of: (a) item transactions; (b) activities and interactions with other individuals; and (c) reporting of activities and transactions;
detecting an initiation of said actions initiated by said individual via said electronic device;
activating one or more functions provided by said data processing system in order to execute said actions initiated by said individual;
in response to an activation of said one or more functions provided by said data processing system, providing notification of execution of said action to said electronic device;
recording information about said actions; and
automatically reporting information about said actions initiated by said individual to one or more of: (a) a first application within said data processing device; (b) a second application on a remote server; and (c) a community networking website application.

9. The data processing system of claim 8, wherein said functions for reporting further comprises functions for:
configuring said community networking website application to receive said information about said actions reported;
detecting receipt of said information reported to said community networking website application;
recording said information about actions initiated by said individual within said community networking website application;
displaying said information about actions initiated by said individual within said community networking website application as one or more of: (a) a record which is publicly displayed; and (b) a record which is privately displayed;
translating said information about actions initiated by said individual into advertising content;
displaying said advertising content within said community networking website application;
providing multiple instances of said advertising content displayed, according to a multiplier advertising mechanism; and
according to said information about actions initiated by said individual, automatically initiating a broadcast of actions and ongoing activities initiated by said individual.

10. The data processing system of claim 8, further comprising functions for:
enabling said action initiated by said individual to be reported to one or more of: (a) said data processing device; and (b) a server on a remote network;
pre-selecting one or more of: (a) automatic responses to particular actions; (b) notification messages corresponding to particular actions;
providing automatic responses by one or more of: (a) a response within a local network; (b) a response within a remote network;
when said individual initiate activities/transactions involving other individuals or other activities, providing one or more automatic responses, wherein said one or more automatic responses include an initiation of a request for online friendship from said individual to said other individuals;
wherein said one or more automatic responses include an activation of functions provided by said community networking website application;
recording information about said activation of functions provided by said community networking website application;
displaying information about said activation of functions provided by said community networking website application; and
reporting information about said activation of functions provided by said community networking website application to said data processing device.

11. The data processing system of claim 8, wherein said functions for reporting further comprises functions for:
creating specialized categories of demographic groups based on a compilation of information reported by a particular establishment about a set of actions initiated by one or more individuals;
identifying said individual as a group member of one or more of said specialized categories of demographic groups based on reported actions of said individual;
compiling population lists for the specialized categories of demographic groups according to reported actions and activities of individuals;
determining an affinity factor for a level of association said individual has with a particular item or action;
dynamically updating the affinity factor when a new instance of a reported activity associating said individual with the particular item or action is identified;
according to reported information, determining in relation to said individual a causal factor for a level of association between one or more of: (a) multiple items; (b) multiple actions; and (c) multiple items and actions;
dynamically updating the causal factor when a relevant new instance of a reported activity by said individual is identified;
determining a recency factor for a level of recent activity that associates said individual with the particular item or action;
dynamically updating the recency factor based on one or more of: (a) a relevant new instance of a reported activity by said individual is identified; and (b) an expiration of previously reported activities, according to a criterion used to determine said recency factor;
selecting a target audience based on one or more of: (a) the affinity factor; (b) the causal factor; and (c) the recency factor;
forwarding advertising content to said target audience; and
obtaining a forecast of a level of interest in a future event based on specific activities which are associated with forecast indicators;
wherein said forecast indicators are obtained from one or more of: (a) RSVP notifications; (b) pre-orders including bids; (c) a level of item trading; (d) observed transaction trends; (e) other forms of pre-event notifications.

12. The data processing system of claim 8, wherein said functions for configuring further comprises functions for:
enabling said individual to create and configure one or more personal area networks (PANs) within a local area network (LAN); and
enabling communication of messages between friends connected via said PAN; and
automatically providing notification messages about selected activities of said individual to friends of said individual connected to said PAN, according to preset configuration parameters.

13. The data processing system of claim 8, further comprising functions for:
enabling said individual to develop a definition of a new item for a particular establishment in order to provide: (a) transactions pertaining to said new item; and (b) interactions associated with said new item;
transmitting information about said definition of said new item to a product development representative for evaluation of said new item;
detecting receipt by said individual of a application decision notification from said product development representative;
receiving a copy of said application decision notification;
retrieving new item information from said copy of said application decision notification;
recording said new item information;
wherein said new item information provides indication of one or more of: (a) final item composition; (b) new item price; and (c) other implementation parameters;
pre-selecting a reporting schedule for transmission of said new item information to one or more of: (a) said first application within said data processing device; (b) said second application on a remote server; and (c) said community networking website application; and
according to said reporting schedule, when said new item information is recorded in said data processing system, transmitting a report containing said new item information to one or more of: (a) said first application within said data processing device; (b) said second application on a remote server; and (c) said community networking website application.

14. The data processing system of claim 8, further comprising functions for:
mapping advertising content displayed including display website links to said individual;
associating orders and transactions to hypertext links mapped to particular member; and
notifying said individual of activities including transactions completed via said website links; and
automatically providing said individual with compensation based on activities including transactions executed via said website links.

15. A computer program product comprising:
a computer readable medium; and
program code on said computer readable medium that when executed within a data processing device, said program code provides the functionality of:
configuring an electronic device to enable an individual to use said electronic device to initiate actions including one or more of: (a) item transactions; (b) activities and interactions with other individuals; and (c) reporting of activities and transactions;
detecting an initiation of said actions initiated by said individual via said electronic device;
activating one or more functions provided by said data processing system in order to execute said actions initiated by said individual;
in response to an activation of said one or more functions provided by said data processing system, providing notification of execution of said action to said electronic device;
recording information about said actions; and
automatically reporting information about said actions initiated by said individual to one or more of: (a) a first application within said data processing device; (b) a second application on a remote server; and (c) a community networking website application.

16. The computer program product of claim 15, wherein said program code for reporting further comprises program code for:
configuring said community networking website application to receive said information about said actions reported;
detecting receipt of said information reported to said community networking website application;
recording said information about actions initiated by said individual within said community networking website application;
displaying said information about actions initiated by said individual within said community networking website application as one or more of: (a) a record which is publicly displayed; and (b) a record which is privately displayed;
translating said information about actions initiated by said individual into advertising content;
displaying said advertising content within said community networking website application;
providing multiple instances of said advertising content displayed, according to a multiplier advertising mechanism; and
according to said information about actions initiated by said individual, automatically initiating a broadcast of actions and ongoing activities initiated by said individual.

17. The computer program product of claim 15, further comprising program code for:
enabling said action initiated by said individual to be reported to one or more of: (a) said data processing device; and (b) a server on a remote network;
pre-selecting one or more of: (a) automatic responses to particular actions; (b) notification messages corresponding to particular actions;
providing automatic responses by one or more of: (a) a response within a local network; (b) a response within a remote network;
when said individual initiate transactions involving other individuals or interactions, providing one or more automatic responses, wherein said one or more automatic responses include an initiation of a request for online friendship;
wherein said one or more automatic responses include an activation of functions provided by said community networking website application;
recording information about said activation of functions provided by said community networking website application;
displaying information about said activation of functions provided by said community networking website application; and
reporting information about said activation of functions provided by said community networking website application to said data processing device.

18. The computer program product of claim 15, wherein said program code for reporting further comprises program code for:
creating specialized categories of demographic groups based on a compilation of information reported by a particular establishment about a set of actions initiated by one or more individuals;
identifying said individual as a group member of one or more of said specialized categories of demographic groups based on reported actions of said individual;
compiling population lists for the specialized categories of demographic groups according to reported actions and activities of individuals;
determining an affinity factor for a level of association said individual has with a particular item or action;
dynamically updating the affinity factor when a new instance of a reported activity associating said individual with the particular item or action is identified;
according to reported information, determining in relation to said individual a causal factor for a level of association between one or more of: (a) multiple items; (b) multiple actions; and (c) multiple items and actions;
dynamically updating the causal factor when a relevant new instance of a reported activity by said individual is identified;
determining a recency factor for a level of recent activity that associates said individual with the particular item or action;
dynamically updating the recency factor based on one or more of: (a) a relevant new instance of a reported activity by said individual is identified; and (b) an expiration of previously reported activities, according to a criterion used to determine said recency factor;
selecting a target audience based on one or more of: (a) the affinity factor; (b) the causal factor; and (c) the recency factor;
forwarding advertising content to said target audience; and
obtaining a forecast of a level of interest in a future event based on specific activities which are associated with forecast indicators;
wherein said forecast indicators are obtained from one or more of: (a) RSVP notifications; (b) pre-orders including bids; (c) a level of item trading; (d) observed transaction trends; (e) other forms of pre-event notifications.

19. The computer program product of claim 15, wherein said program code for configuring further comprises program code for:
enabling said individual to create and configure one or more personal area networks (PANs) within a local area network (LAN); and
enabling communication of messages between friends connected via said PAN; and
automatically providing notification messages about selected activities of said individual to friends of said individual connected to said PAN, according to preset configuration parameters.

20. The computer program product of claim 15, further comprising program code for:
enabling said individual to develop a definition of a new item for a particular establishment in order to provide: (a) transactions pertaining to said new item; and (b) interactions associated with said new item;
transmitting information about said definition of said new item to a product development representative for evaluation of said new item;
detecting receipt by said individual of a application decision notification from said product development representative;
receiving a copy of said application decision notification;
retrieving new item information from said copy of said application decision notification;
recording said new item information;
wherein said new item information provides indication of one or more of: (a) final item composition; (b) new item price; and (c) other implementation parameters;
pre-selecting a reporting schedule for transmission of said new item information to one or more of: (a) said first application within said data processing device; (b) said second application on a remote server; and (c) said community networking website application;
according to said reporting schedule, when said new item information is recorded in said data processing system, transmitting a report containing said new item information to one or more of: (a) said first application within said data processing device; (b) said second application on a remote server; and (c) said community networking website application;
mapping advertising content displayed including display website links to said individual;
associating orders and transactions to hypertext links mapped to particular member; and
notifying said individual of activities including transactions completed via said website links; and
automatically providing said individual with compensation based on activities including transactions executed via said website links.
